(19) United States
(12) Patent Application Publication
(10) Pub. No.: US 2024/0008417 A1
(43) Pub. Date: Jan. 11, 2024

(54) SYSTEMS AND METHODS FOR ELECTROMAGNETIC TREATMENT OF PLANTS

(71) Applicant: BRIGHT YETI, INC., Denver, CO (US)

(72) Inventors: Jacob CORDOVA, Denver, CO (US); Miles INGWERS, Denver, CO (US)

(73) Assignee: BRIGHT YETI, INC., Denver, CO (US)

(21) Appl. No.: 18/253,230

(22) PCT Filed: Nov. 17, 2021
(86) PCT No.: PCT/US2021/059738

§ 371 Date: May 17, 2023

Related U.S. Application Data
(60) Provisional application No. 63/114,889, filed on Nov. 17, 2020.

(51) Int. Cl. A01G 7/04; A01C 1/02; G06Q 50/02; G05F 1/10

(52) U.S. Cl. CPC A01G 7/04; A01C 1/02; G06Q 50/02; G05F 1/10

(57) ABSTRACT

Disclosed herein are methods and systems for electromagnetic treatment of a plant and/or seed. The electromagnetic treatment can improve or modify plant and/or seed growth, development, chemical profile, appearance, tolerances, etc. The electromagnetic treatment can also reduce plant and/or seed pests.

### CROSS REFERENCE TO RELATED PATENT APPLICATIONS

This application claims the benefit of priority to U.S. Provisional Patent Application Ser. No. 63/114,889, filed Nov. 17, 2020, hereby incorporated by reference in its entirety.

### BACKGROUND OF THE INVENTION

### A. Field of the Invention

The field of the invention is plant and/or seed system treatment methods. Specifically, electromagnetic plant and/or seed systems and treatment methods that can include modification of any characteristic of a plant and/or seed, or modification of the behavior or survivability of plant and/or seed pests.

### B. Description of Related Art

By 2050, the human population of the world is expected to increase by more than 35%. It is projected that crop production will need to at least double to feed the world's population in 2050. Currently, chemical or organic fertilizers and pesticides can be used to increase crop production. However, in many cases, fertilizers must be tailored for the specific soil type and climate where the crop is produced and pesticides must be carefully regulated and carefully used. Further, fertilizers and pesticides can have unwanted effects on the environment and the crop production itself. For example, over fertilization can increase growth of unwanted organisms at the treatment area and downstream and can cause depletion of other nutrients in the soil that are not replaced by the fertilizer itself. Resistance to pesticides can occur and pesticides can be detrimental to beneficial organisms in the treatment area or downstream. In addition, some fertilizers, when left on the crop plant can be harmful to human health when contacted or consumed. Also concerning is the likelihood that increasing the world's crop production by the means currently available is not likely to keep up with demand.

Some have attempted to increase crop production or improve desirable characteristics of plants by genetically modifying plants or changing the growth conditions of the plant. Genetic modification can occur through selective breeding, screening plants for desired traits, mutational breeding, gene transfer, gene editing, etc. Some of these modification methods are considered undesirable or unacceptable by some consumers. Further, some of these modification methods are expensive and take many years to develop.

Overall, the need for improvements in this field persists in light of at least the aforementioned drawbacks for the currently available methods and systems.

### SUMMARY OF THE INVENTION

A solution to at least some of the above-mentioned problems has been discovered. The solution resides in electromagnetic treatments of plants and/or seeds. Disclosed herein are electromagnetic treatment recipes, methods of treatments, and systems and apparatuses to treat plants and/or seeds with said electromagnetic treatments. It has been found that the treatments can modify mass of at least a portion of the plant, yield of the plant, germination rate, germination timing, time to emergence of a coleoptile, time to emergence of a first true leaf, cold tolerance, membrane permeability, nutrient uptake, gene transcription, gene expression, cell growth, cell division, protein synthesis, latent heat flux, carbon assimilation, stomatal conductance, quantum efficiency of PSII reaction centers, efficiency of energy harvesting by oxidized PSII reaction centers, variable fluorescence, fluorescence value at first inflection point, sensible heat flux, net thermal balance, transpiration rate, CO₂ assimilation rate, intercellular CO₂, stomatal conductance to water vapor, boundary layer conductance to water vapor, total conductance to water vapor, total conductance to CO₂, steady-state fluorescence, maximum fluorescence, quantum yield of photosystem II, electron transport rate, quantum yield calculated from CO₂ assimilation, non-photochemical quenching, photochemical quenching, non-photochemical quenching, fluorescence, initial fluorescence yield, the chemical profile in at least a portion of the plant, the cannabinoid profile, the terpene profile, trichome content, the time required for harvest readiness, rooting development rate, water use efficiency, nutrient use efficiency, time to develop mature flowers, time to set fruit, plant height, plant width, ratio of vegetative tissue to flower tissue, ratio of vegetative tissue to fruit tissue, quantity of flowering, lateral organs, and/or vegetative node sites, internode spacing, attracting or increasing the amounts of beneficial organisms, and/or repel and/or decrease the amount of pests on the plant and/or seed, as compared to a plant and/or seed that is not treated.

Inducing and/or increasing and/or altering the expression of plant secondary compounds may have many benefits. Plant secondary compounds can include compounds produced as adaptation of plants to their environment and/or compounds not directly involved in normal growth, development, or reproduction of the plant. Plant secondary compounds can include secondary metabolites. Altered, as used herein, may also include a decrease in the expression of a plant secondary compound, or modification of the relative abundance of one or more plant secondary compounds independently or in combination with other plant secondary compounds. Non-limiting examples of the benefits of inducing and/or increasing and/or altering the expression of plant secondary compounds include an impact on plant abiotic stress tolerance, biotic stress tolerance, plant growth and performance, flavor and aroma of plant products, medical, recreational and therapeutic benefits among many more. Of particular interest are terpenes and cannabinoids and the many aforementioned benefits associated with them.

In one aspect, a plant treatment system is disclosed. A “plant” may refer to either the adult plant, seedling, seed, or any portion of a plant and/or seed. The treatment system can be capable of producing any of the electromagnetic plant and/or seed treatments disclosed herein. In some instances, the treatment system includes a function generator configured to provide a voltage and/or current used to generate an electromagnetic field. The function generator may be any component capable of producing a voltage output, and that voltage output, when applied to a radiating structure, generates the electromagnetic field for plant and/or seed treatment. The function generator may generate an arbitrary voltage output to be an electromagnetic signal according to a predetermined or programmable recipe. The recipes may be dynamic and adjust to conditions. For example, if one recipe works best for the first 4 weeks of a plants life during seedling and root development, then a separate recipe works best for the last 4 weeks of a plants life for vegetative development, the system can automatically adjust recipes for the user. In some embodiments, the function generator may generate an electromagnetic signal by modulating a carrier wave. In some embodiments, the function generator may be controlled by a single timer and/or sensor or a combination of timers and/or sensors. In other embodiments, the function generator may be controlled by a computational system configured to receive an input specifying parameters for controlling the function generator and to control the function generator to control generation of the electromagnetic field according to the input. In some instances, the computational system can be merely a system that controls voltage and/or to create a treatment signal. In some instances, the computational system can be a generic computer, a timer, a relay, a function generator, etc. In some embodiments, the function generator may be a transformer. In some instances, the transformer can be an alternating current (AC) to direct current (DC) transformer. In some instances, the transformer can be a DC to AC transformer. In some instances, a transformer is not included and/or not required. In some instances, the treatment system can receive instructions for a treatment recipe wirelessly from a central server. The central server may control any aspect of the electromagnetic plant and/or seed treatment system. The central server may be, for example, a cloud-based management system with AI/machine learning capability or a simple remote control. The treatment system(s) can also receive instructions for more than one treatment recipe. The treatment system(s), in some instances, can change the electromagnetic recipe delivered by the system. In this way, the same system can be used to provide treatment to a plant and/or seed at different stages of growth or development, can be used to treat the same plant and/or seed with different recipes that target a variety of different modifications that target to a variety of different organisms and/or biological process modifications, and/or can be used to treat different plants and/or seeds.

In one aspect, an electromagnetic plant and/or seed treatment is disclosed. The electromagnetic plant and/or seed treatment can include an electromagnetic field comprising a carrier frequency and a carrier waveform. In some instances, a carrier is not used. Optionally, the electromagnetic field can be modulated with a modulating wave to produce a modulated electromagnetic field. In some instances, the electromagnetic field is not modulated. The modulating wave can have a modulating frequency, a modulating waveform, and/or an amplitude modulating index. In some instances, the electromagnetic treatment, at least in part, mimics or enhances naturally occurring changes that can occur in the plant, seed, pest, environment, organisms, or other biological processes. In some instances, the treatment may mimic in part an ion cyclotron resonance frequency of an ion or molecule such as, but not limited to, calcium, potassium, magnesium, iron, copper, phosphate, phosphorous, and/or nitrogen. In some instances, the electromagnetic treatment mimics in part an environmental change, such as, but not limited to a change in ion concentration or electromagnetic field that occurs due to a storm (e.g., increase/decrease in voltage due to the storm).

In another aspect, a method of treating a plant and/or seeds is disclosed. The method can include treating a plant, seed, and/or part of a plant and/or seed, and/or environment surrounding a plant and/or seed, with any one of the electromagnetic plant and/or seed treatments disclosed herein. In some instances, the method is carried out at least in part by any one of the treatment systems disclosed herein. The plant and/or seed treated can be any plant and/or seed, such as a crop plant, an ornamental plant, a medicinal plant, or a plant used for beneficial uses such as ground cover, reduction of soil erosion the receding or changing of shores or banks, providing shade or shelter, reintroduction or increasing the number of plants or plant species in an area, etc. The treatment can be applied, stopped, or modified according to a timing, environmental change, plant life cycle, event such as watering, trigger of a sensor, etc., or can be constant.

In another aspect, a method of treating a plant and/or seeds is disclosed. The method can include treating a plant, seed, and/or part of a plant and/or seed, and/or environment surrounding a plant and/or seed, with any one of the electromagnetic plant and/or seed treatments disclosed herein. In some instances, the method is carried out at least in part by any one of the treatment systems disclosed herein. In some instances, the stress on a plant and/or seeds is increased and/or altered using the electromagnetic systems and treatments disclosed. Increasing stress can increase the synthesis of secondary compounds and expression of specific genes and/or proteins associated with a plant and/or seed stress response, which in some cases may be cannabinoids and/or terpenes. Different applications of the technology may increase and/or alter plant and/or seed stress and/or one or more plant and/or seed processes associated with increase or alteration in plant and/or seed stress. Some non-limiting examples include increased production of terpenes and other secondary compounds, which for example may have commercial or therapeutic value, or be useful for defense against pests; syntheses of heat-shock or other proteins related to abiotic stress; and changes in plant and/or seed form or development. Additionally, stress on a plant and/or seed may be increased and/or altered through one or more secondary effects such as by effecting biotic or abiotic pathogens and/or organisms.

In another aspect, electromagnetic treatment may stimulate or otherwise affect any class of molecules, including but not limited to proteins, carbohydrates, nucleic acids, lipids, and/or any combination thereof, organelles inside, microorganisms inside, outside, associated with, attached to, in proximity to, plants on leaves, fruits, roots, seeds, etc. that affect the growth and vitality of the plant and/or seed.

Disclosed herein is a method of producing secondary compounds in a plant of genus cannabis. In aspects, the methods induce trichome development in a plant of genus cannabis. In aspects, the methods induce and/or alter development of other plant structures. In some embodiments, the secondary compounds are chosen from cannabinoids, terpenes, or flavonoids.

As used herein, the term “terpene” means an organic compound built on an isoprenoid structural scaffold or produced by combining isoprene units. Often, terpene molecules found in plants may produce aroma and/or flavor.

The structure of terpenes are built with isoprene units, which are 5 carbon structures. Flavonoids are generally considered to be 15 carbon structures with two phenyl rings and a heterocyclic ring. So, there could be an overlap in which a flavonoid could be considered a terpene. However, not all terpenes could be considered flavonoids. The systems and methods herein include any of cannabinoids, terpenes, or flavonoids, in addition to other plant compounds.

The term terpene includes but is not limited to Hemiterpenes, Monoterpenols, Terpene esters, Diterpenes, Monoterpenes, Polyterpenes, Tetraterpenes, Terpenoid oxides, Sesterterpenes, Sesquiterpenes, Norisoprenoids, or their derivatives.

Derivatives of terpenes include but are not limited to terpenoids in their forms of hemiterpenoids, monoterpenoids, sesquiterpenoids, sesterterpenoid, sesquarterpenoids, tetraterpenoids, Triterpenoids, tetraterpenoids, Polyterpenoids, isoprenoids, and steroids. They may be forms: α-, β-, γ-, oχo-, isomers, or combinations thereof.

Examples of terpenes include but are not limited to: 7,8-dihydroionone, Acetanisole, Acetic Acid, Acetyl Cedrene, Anethole, Anisole, Benzaldehyde, Bergamotene (a-cis-Bergamotene) (a-trans-Bergamotene), Bisabolol (β-Bisabolol), Borneol, Bornyl Acetate, Butanoic/Butyric Acid, Cadinene (a-Cadinene) (γ-Cadinene), Cafestol, Caffeic acid, Camphene, Camphor, Capsaicin, Carene (Δ-3-Carene), Carotene, Carvacrol, Carvone, Dextro-Carvone, Laevo-Carvone, Caryophyllene (β-Caryophyllene), Caryophyllene oxide, Castoreum Absolute, Cedrene (a-Cedrene) (β-Cedrene), Cedrene Epoxide (a-Cedrene Epoxide), Cedrol, Cembrene, Chlorogenic Acid, Cinnamaldehyde (a-amyl-Cinnamaldehyde) (a-hexyl-Cinnamaldehyde), Cinnamic Acid, Cinnamyl Alcohol, Citronellal, Citronellol, Cryptone, Curcumene (a-Curcumene) (γ-Curcumene), Decanal, Dehydrovomifoliol, Diallyl Disulfide, Dihydroactinidiolide, Dimethyl Disulfide, Eicosane/lcosane, Elemene (β-Elemene), Estragole, Ethyl acetate, Ethyl Cinnamate, Ethyl maltol, Eucalyptol/1,8-Cineole, Eudesmol (a-Eudesmol) (β-Eudesmol) (γ-Eudesmol), Eugenol, Euphol, Farnesene, Farnesol, Fenchol (s-Fenchol), Fenchone, Geraniol, Geranyl acetate, Germacrenes, Germacrene B, Guaia-1 (10), 1 1-diene, Guaiacol, Guaiene (a-Guaiene), Gurjunene (a-Gurjunene), Herniarin, Hexanaldehyde, Hexanoic Acid, Humulene (a-Humulene) (β-Humulene), lonol (3-oxo-a-ionol) (β-lonol), lonone (a-lonone) (β-lonone), Ipsdienol, Isoamyl acetate, Isoamyl Alcohol, Isoamyl Formate, Isoborneol, Isomyrcenol, Isopulegol, Isovaleric Acid, Isoprene, Kahweol, Lavandulol, Limonene, γ-Linolenic Acid, Linalool, Longifolene, a-Longipinene, Lycopene, Menthol, Methyl butyrate, 3-Mercapto-2-Methylpentanal, Mercaptan/Thiols, β-Mercaptoethanol, Mercaptoacetic Acid, Allyl Mercaptan, Benzyl Mercaptan, Butyl Mercaptan, Ethyl Mercaptan, Methyl Mercaptan, Furfuryl Mercaptan, Ethylene Mercaptan, Propyl Mercaptan, Thenyl Mercaptan, Methyl Salicylate, Methylbutenol, Methyl-2-Methylvalerate, Methyl Thiobutyrate, Myrcene (β-Myrcene), γ-Muurolene, Nepetalactone, Nerol, Nerolidol, Neryl acetate, Nonanaldehyde, Nonanoic Acid, Ocimene, Octanal, Octanoic Acid, P-cymene, Pentyl butyrate, Phellandrene, Phenylacetaldehyde, Phenylethanethiol, Phenylacetic Acid, Phytol, Pinene, s-Pinene, Propanethiol, Pristimerin, Pulegone, Quercetin, Retinol, Rutin, Sabinene, Sabinene Hydrate, cis-Sabinene Hydrate, trans-Sabinene Hydrate, Safranal, a-Selinene, a-Sinensal, β-Sinensal, β-Sitosterol, Squalene, Taxadiene, Terpin hydrate, Terpineol, Terpine-4-ol, a-Terpinene, Y-Terpinene, Terpinolene, Thiophenol, Thujone, Thymol, a-Tocopherol, Tonka Undecanone, Undecanal, Valeraldehyde/Pentanal, Verdoxan, a-Ylangene, Umbelliferone, or Vanillin.

The term “cannabinoid” means any substance that acts upon a cannabinoid receptor. For example the term cannabinoid includes cannabinoid ligands such as agonists, partial agonists, inverse agonists, or antagonists, as demonstrated by binding studies and functional assays. In many examples, a cannabinoid can be identified because its chemical name will include the text string “*cannabi* in the name. Within the context of this application, where reference is made to a particular cannabinoid, each of the acid and/or decarboxylated forms are contemplated as both single molecules and mixtures.

Examples of cannabinoids include but are not limited to compounds belonging to any of the following classes of molecules, their derivatives, salts, or analogs: Tetrahydrocannabinol (THC), Tetrahydrocannabivarin (THCV), Cannabichromene (CBC), Cannabichromanon (CBCN), Cannabidiol (CBD), Cannabielsoin (CBE), Cannabidivarin (CBDV), Cannbifuran (CBF), Cannabigerol (CBG), Cannabicyclol (CBL), Cannabinol (CBN), Cannabinodiol (CBND), Cannabitriol (CBT), Cannabivarin (CBV), and Isocanabinoids.

Some of the impacts caused by the electromagnetic treatments described herein include but are not limited to:

Increased and/or altered presence of one or more above ground biomass plant structures.

Increased and/or altered presence of one or more below ground biomass plant structures.

Increased and/or altered presence of one or more root development plant structures.

Increased and/or altered presence of one or more adventitious root development plant structures.

Increased and/or altered presence of one or more cannabinoids.

Increased and/or altered presence of one or more terpenes.

Increased and/or altered presence of one or more intra cellular ions.

Increased and/or altered presence of one or more extra cellular ions.

Increased and/or altered presence of one or more primary compounds.

Increased and/or altered presence of one or more secondary metabolites.

Increased and/or altered presence of one or more secondary compounds.

Increased and/or altered presence of one or more secondary metabolites.

Increased and/or altered presence of one or more ions.

Increased and/or altered overall cannabinoids.

Increased and/or altered overall terpenes.

Increased and/or altered overall intra cellular ions.

Increased and/or altered overall extra cellular ions.

Increased and/or altered overall secondary compounds.

Increased and/or altered overall secondary metabolites.

Increased and/or altered overall ions.

Increased and/or altered abiotic tolerance.

Increased and/or altered biotic tolerance.

Increased and/or altered flavor.

Increased and/or altered aroma.

Increased and/or altered therapeutic value.

Increased and/or altered resistance to pests.

Increased and/or altered resistance to viruses.

Increased and/or altered resistance to insects.

Increased and/or altered resistance to microbes.

Increased and/or altered resistance to fungi.

Increased and/or altered resistance to biotic stress.

Increased and/or altered resistance to abiotic stress.

Increased and/or altered resistance to moisture stress.

Increased and/or altered resistance to nutrient stress.

Increased and/or altered resistance to temperature stress.

Increased and/or altered resistance to atmospheric carbon concentration stress.

Increased and/or altered resistance to light stress.

Increased and/or altered respiration.

Increased and/or altered cell wall plasticity.

Increased and/or altered cell wall permeability.

Increased and/or altered membrane plasticity.

Increased and/or altered membrane permeability.

Increased and/or altered organelle plasticity.

Increased and/or altered organelle permeability.

Increased and/or altered changes in internal ionic concentration.

Increased and/or altered changes in external ionic concentration.

Increased and/or altered changes in internal molecular concentration.

Increased and/or altered changes in external molecular concentration.

Increased and/or altered changes in molecular orientation.

Increased and/or altered activation energy required to move ions across a membrane.

Increased and/or altered activation energy required to move ions across a cell wall.

Increased and/or altered internal microbial communities.

Increased and/or altered external microbial communities.

Increased and/or altered plant and/or seed physiology.

Increased and/or altered osmoregulation.

Decreased and/or altered time to emergence of a coleoptile.

Decreased and/or altered time to emergence of a first true leaf.

Increased and/or altered cold tolerance.

Increased and/or altered drought tolerance

Increased and/or altered assimilation.

Increased and/or altered transpiration.

Increased and/or altered water acquisition.

Increased and/or altered water use efficiency.

Increased and/or altered water potential.

Increased and/or altered nutrient acquisition.

Increased and/or altered nutrient use efficiency.

Increased and/or altered nutrient use productivity.

Increased and/or altered plant maturation.

Increased and/or altered vigor.

Increased and/or altered time elapsed between life cycle development points.

Increased and/or altered germination.

Increased and/or altered metabolism.

Increased and/or altered carbon assimilation.

Increased and/or altered sequestration.

Increased and/or altered plant structural morphology.

Increased and/or altered organelle activity.

Increased and/or altered protein activity.

Increased and/or altered carbohydrate activity.

Increased and/or altered nucleic acid activity.

Increased and/or altered lipid activity.

Increased and/or altered microorganism activity.

Increased and/or altered transcription.

Increased and/or altered gene expression.

Increased and/or altered cell growth.

Increased and/or altered cell division.

Increased and/or altered protein synthesis.

Increased and/or altered latent heat flux.

Increased and/or altered carbon assimilation.

Increased and/or altered stomatal conductance.

Increased and/or altered quantum efficiency of PSII reaction centers.

Increased and/or altered efficiency of energy harvesting by oxidized PSII reaction centers.

Increased and/or altered variable fluorescence.

Increased and/or altered fluorescence value at first inflection point.

Increased and/or altered sensible heat flux.

Increased and/or altered net thermal balance.

Increased and/or altered intercellular CO₂.

Increased and/or altered stomatal conductance to water vapor.

Increased and/or altered boundary layer conductance to water vapor.

Increased and/or altered total conductance to water vapor.

Increased and/or altered total conductance to CO₂.

Increased and/or altered steady-state fluorescence.

Increased and/or altered maximum fluorescence.

Increased and/or altered quantum yield of photosystem II.

Increased and/or altered electron transport.

Increased and/or altered quantum yield calculated from CO₂ assimilation.

Increased and/or altered non-photochemical quenching.

Increased and/or altered photochemical quenching.

Increased and/or altered non-photochemical quenching.

Increased and/or altered fluorescence.

Increased and/or altered initial fluorescence yield.

Increased and/or altered the chemical profile in at least a portion of the plant and/or seed.

Increased and/or altered the cannabinoid profile.

Increased and/or altered the terpene profile.

Increased and/or altered the flavonoid profile.

Increased and/or altered the time required for harvest readiness.

Increased and/or altered rooting development rate.

Increased and/or altered water use efficiency.

Increased and/or altered nutrient use efficiency.

Increased and/or altered time to develop mature flowers.

Increased and/or altered time to set fruit.

Increased and/or altered plant height.

Increased and/or altered plant width.

Increased and/or altered ratio of vegetative tissue to flower tissue.

Increased and/or altered ratio of vegetative tissue to fruit tissue.

Increased and/or altered quantity of flowering.

Increased and/or altered lateral organs.

Increased and/or altered and/or vegetative node sites.

Increased and/or altered internode spacing.

Increased and/or altered attracting or increasing the amounts of beneficial organisms.

Increased and/or altered repelling of the amount of pests on the plant and/or seed.

Increased and/or altered therapeutic value of plant and/or seed-derived products such as, but not limited to, anticancer and chemotherapy, antimicrobial, antifungal, antiviral, antiparasitic, anti-inflammatory, and/or antihyperglycemic anti-inflammatory products.

Any of the above impacts may be observed or induced alone or in any combination thereof.

The following includes definitions of various terms and phrases used throughout this specification.

The terms “about,” “approximately,” and “substantially” are defined as being close to, as understood by one of ordinary skill in the art. In one non-limiting instance, the terms are defined to be within 10%, preferably within 5%, more preferably within 1%, and most preferably within 0.5%.

The terms “wt. %,” “vol. %,” or “mol. %” refers to a weight, volume, or molar percentage of a component, respectively, based on the total weight, the total volume, or the total moles of material that includes the component. In a non-limiting example, 10 grams of a component in 100 grams of the material that includes the component is 10 wt. % of component.

The use of the words “a” or “an” when used in conjunction with any of the terms “comprising,” “including,” “containing,” or “having” in the claims or the specification may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”), or “containing” (and any form of containing, such as “contains” and “contain”) are inclusive or open-ended and do not exclude additional, unrecited elements or method steps.

The compositions and process of the present invention can “comprise,” “consist essentially of,” or “consist of” particular ingredients, components, compositions, etc., disclosed throughout the specification. With respect to the transitional phase “consisting essentially of,” in one non-limiting aspect, a basic and novel characteristic of the treatment systems and plant and/or seed treatments disclosed herein is that the treatments modify plants and/or seeds through contacting the plant and/or seed with an electromagnetic field designed to modify the plant and/or seed and the systems herein are capable of producing said treatments. In some instances, the systems are capable of receiving instructions for treatments and producing said treatments.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes, combinations, and modifications within the spirit and scope of the invention will become apparent to those skilled in the art from this detailed description.

### BRIEF DESCRIPTION OF THE DRAWINGS

Advantages of the present invention may become apparent to those skilled in the art with the benefit of the following non-limiting detailed description and upon reference to the accompanying non-limiting drawings. The drawings may not be to scale.

FIGS. 1A-1I show a block diagram for electromagnetic treatment recipe delivery systems according to some embodiments of the disclosure.

FIGS. 2A-2D show example radiating structures for delivery of electromagnetic fields to plants and/or seeds according to some embodiments of the disclosure.

FIGS. 3A-3O show other example radiating structures for delivery of electromagnetic fields to plants and/or seeds according to some embodiments of the disclosure.

FIG. 4 shows a system for transmission of electromagnetic treatment recipes and/or authorization codes according to some embodiments of the disclosure.

FIG. 5 shows a flow chart for performing transactions involving electromagnetic treatment recipes according to some embodiments of the disclosure.

FIG. 6 shows a system for secured transactions and encrypted transmission of electromagnetic treatment recipes and/or authorization codes according to some embodiments of the disclosure.

FIG. 7 is a block diagram illustrating an electromagnetic treatment recipe delivery system involving multiple radiating structures according to some embodiments of the disclosure.

FIG. 8 is a chart of average dried flower mass, in grams, among three (3) different Cannabis sativa L. cultivars that received the electromagnetic treatment (right) and did not receive the electromagnetic treatment (left). Number of plants is indicated above each box-plot. Average percent difference is shown in the black box at the top of each box-plot.

FIGS. 9A-9C are charts of impact of electromagnetic treatments on Zea mays seeds for (a) germination, (b) coleoptile emergence and (c) true leaf development.

FIGS. 10A-10C are charts of impact of electromagnetic treatments on cold stressed Zea mays seeds for (a) germination, (b) coleoptile emergence and (c) true leaf development.

### DETAILED DESCRIPTION OF THE INVENTION

Electromagnetic treatment recipes, methods of treatments, and systems and apparatuses to treat plants and/or seeds with said electromagnetic treatments disclosed herein have been developed to increase and/or alter the weight of at least a portion of the plant, yield of the plant, germination rate, germination timing, time to emergence of a coleoptile, time to emergence of a first true leaf, cold tolerance, membrane permeability, nutrient uptake, gene transcription, gene expression, cell growth, cell division, protein synthesis, latent heat flux, carbon assimilation, stomatal conductance, the chemical profile in at least a portion of the plant and/or seed, the cannabinoid profile, the terpene profile, trichome content, the time required for harvest readiness, quantity of flowering sites, internode spacing, plant morphology, and/or repel and/or decrease the amount of pests on the plant and/or seed, as compared to a plant and/or seed that is not treated. In some instances, the electromagnetic treatment, at least in part, mimics or enhances naturally occurring changes that can occur in the plant, seed, pest, or environment. As a non-limiting example, the treatment may mimic in part an ion cyclotron resonance frequency of an ion such calcium, potassium, magnesium, iron, copper, hydronium, phosphate, phosphorous, and/or nitrogen. As another non-limiting example, the electromagnetic treatment mimics in part an environmental change, such as, but not limited to a change in ion concentration or electromagnetic field that occurs due to a storm (e.g., increase electric field in voltage per meter due to the storm).

U.S. Provisional Patent Application No. 62/884,778, filed Aug. 9, 2019, is hereby referenced and incorporated in its entirety

### A. System and Apparatus to Deliver Treatment Recipe

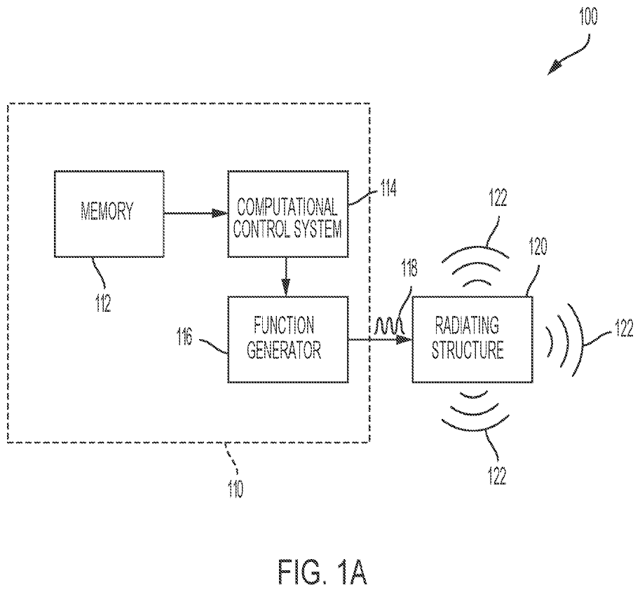

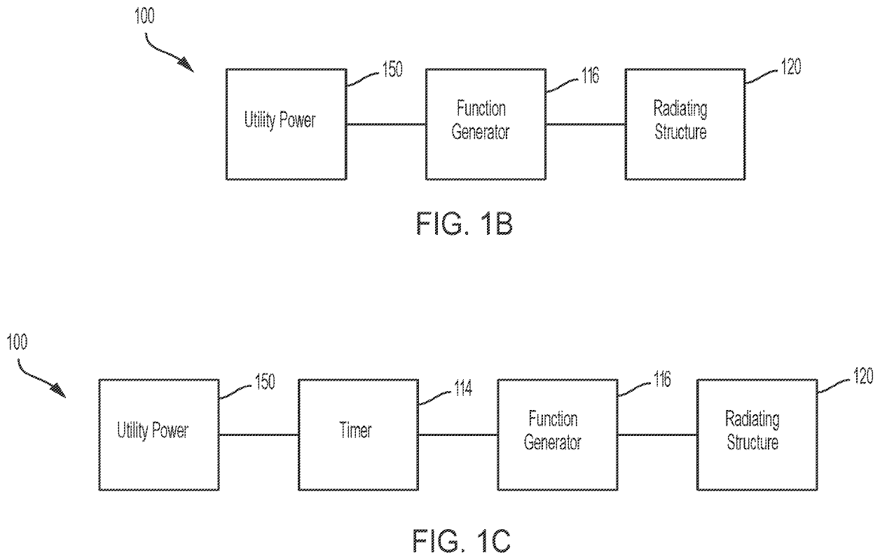

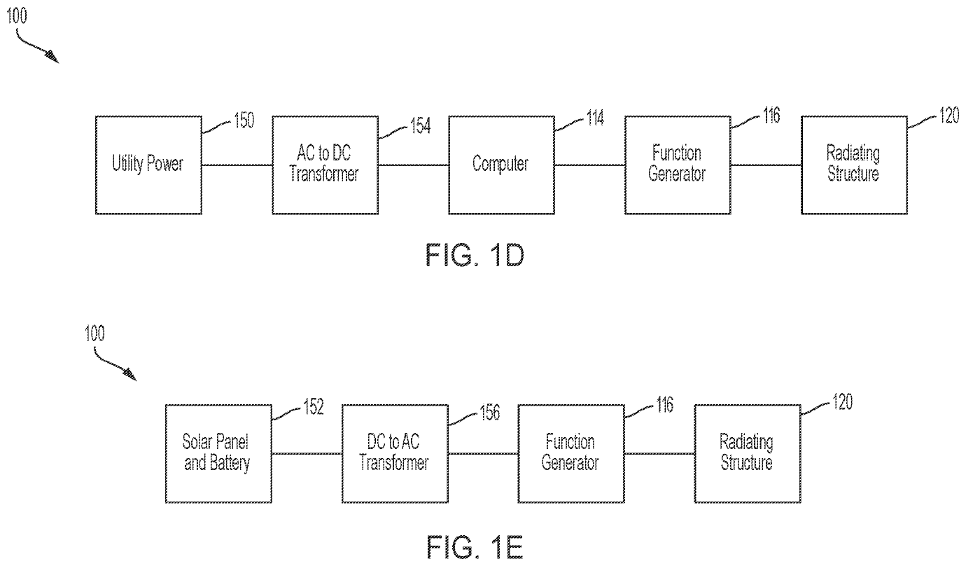

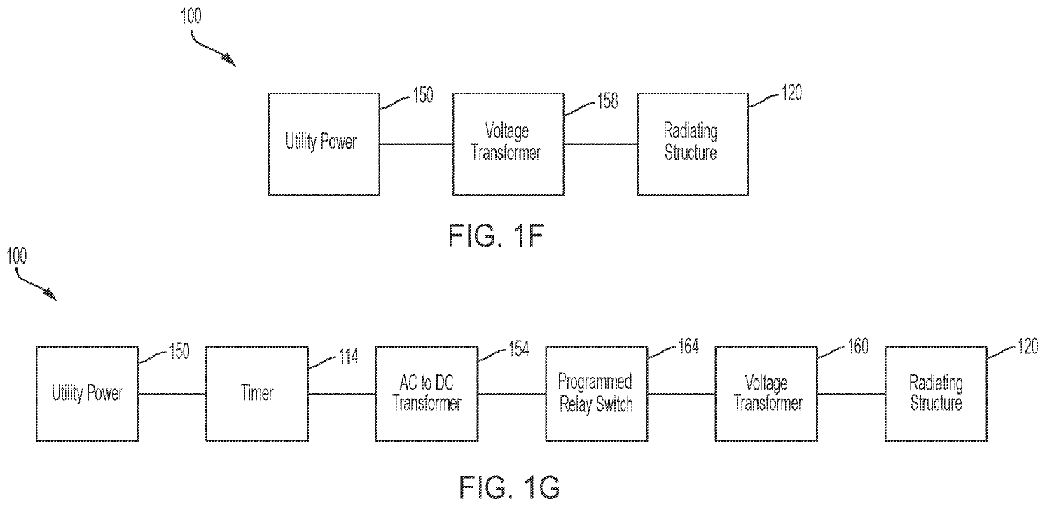

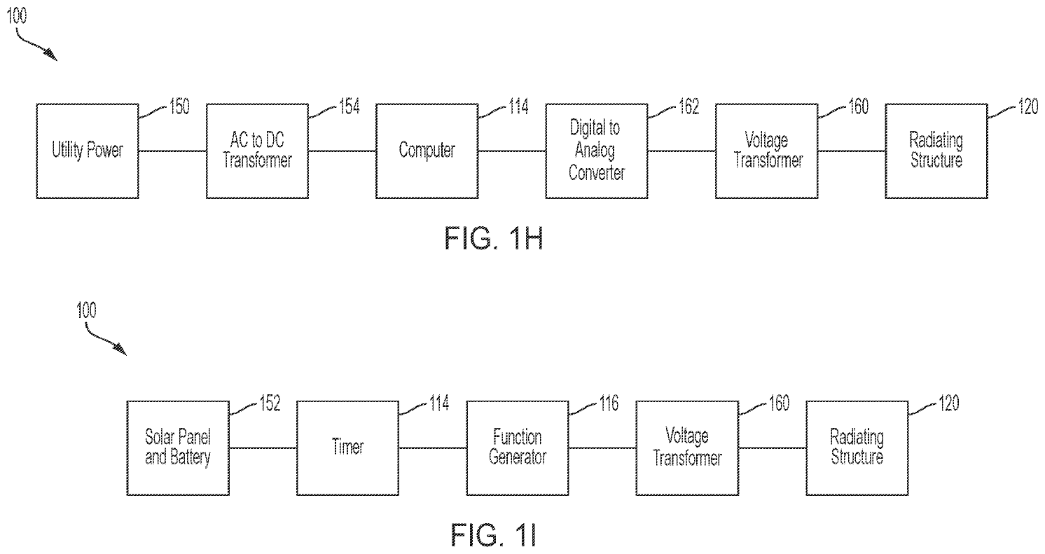

FIG. 1A shows a block diagram for an electromagnetic treatment recipe delivery system according to some embodiments of the disclosure. The treatment system 100 can be capable of producing any of the electromagnetic plant and/or seed treatments disclosed herein. The treatment system 100 includes a function generator 116 configured to generate an electromagnetic signal 118, which when applied to radiating structure 120 produces an electromagnetic field 122, which can be a modulated electromagnetic field or other electromagnetic field created by the recipes disclosed herein.

The system 100 also includes a computational system 114 configured to receive an input specifying the electromagnetic field and optionally the modulating wave and control the function generator 116 to control the generation of the electromagnetic field 122. The function generator 116 may be, for example, a software defined radio (SDR), a transformer, or another waveform generation circuit. The input to the function generator 116 may be a decoded electromagnetic treatment recipe that specifies parameters such as voltage, amplitude, carrier frequency, modulation pattern, etc. The function generator 116 may produce the electromagnetic signal 118 by generating a carrier wave in accordance with the recipe and then optionally modulating the carrier wave in accordance with the recipe.

The electromagnetic treatment recipe may be stored in memory 112, where the recipe is read out by the computational system 114 and decoded. In some embodiments, the treatment system can receive instructions for a treatment recipe wirelessly. In some embodiments, the treatment system stores a recipe book, and individual recipes within the book are unlocked by wireless communications or entering codes into the user system 110. The treatments system 100 can also receive instructions for more than one treatment recipe. The treatment system 100, in some instances, can change the electromagnetic recipe. In this way, the same system can be used to provide treatment to a plant and/or seed at different stages of growth or development, can be used to treat the same plant and/or seed with different recipes that target a variety of different plant/seed/pest modifications, and/or can be used to treat different plants and/or seeds. In some embodiments, the user system 110 may also include a communications adapter, such as a wireless communications adapter, to perform functions described in more detail below.

Other examples of electromagnetic treatment recipe delivery systems are shown in FIGS. 1B-1I. Other configurations for the system may include different forms of computational systems, no computational system, different power sources, and/or different power conversion systems. Any configuration of the electromagnetic treatment recipe delivery systems is configured to operate a radiating structure to cause generation of an electromagnetic field to a plant and/or seeds at levels and times specified by a recipe (either pre-programmed or programmable). FIG. 1B shows a block diagram for an electromagnetic treatment recipe delivery system with a radiating structure 120 powered by function generator 116 fed by utility power 150. Utility power herein can be any power source, such as power from a building outlet, a generator, a battery, a machine alternator, etc. In the embodiment of FIG. 1B, the function generator is configured, such as by being pre-programmed, to generate a particular electromagnetic signal, and can be delivered on-site and plugged in to operate without any further configuring. FIG. 1C shows a block diagram for an electromagnetic treatment recipe delivery system with a radiating structure 120 powered by a function generator 116 controlled by timer 114 and fed by utility power 150. In the embodiment of FIG. 1C, the desired electromagnetic field of the electromagnetic treatment recipe is pre-configured in the function generator 116 and the desired schedule for the electromagnetic field is pre-configured in the timer 114. FIG. 1D shows a block diagram for an electromagnetic treatment recipe delivery system with a radiating structure 120 powered by a function generator 116 coupled to a computational control system 114 and fed by utility power 150 and AC-to-DC transformer 154, though the transformer can also be herein and in the systems of the other figures a DC-to-AC transformer. In some embodiments, the transformer is not used or present herein or in the systems of the other figures. FIG. 1E shows a block diagram for an electromagnetic treatment recipe delivery system with a radiating structure 120 powered by a function generator 116 fed by solar panel and battery 152 and DC-to-AC transformer 156.

FIG. 1F shows a block diagram for an electromagnetic treatment recipe delivery system with a radiating structure 120 powered by a voltage transformer 158 fed by utility power 150. The voltage transformer 158 may be configured to output an electromagnetic signal according to a fixed recipe. In one example, the transformer may be configured to output a voltage and hold it constant for a certain amount of time. In another example, the transformer may be configured to output and fluctuate a voltage using an arbitrary noise waveform. In some embodiments, the voltage transformer can increase and/or decrease voltage and/or control the load. In some instances, the voltage transformer can be a voltage amplifier, transformer, regulator, etc. FIG. 1G shows a block diagram for an electromagnetic treatment recipe delivery system with a radiating structure 120 powered by a voltage transformer 160 coupled to a programmed relay switch 164 coupled to an AC-to-DC transformer 154 coupled to a timer 114 and fed by utility power 150. The fixed electromagnetic field generated by the radiating structure 120 may be toggled according to a pre-programmed schedule using the timer 114 and the programmed relay switch 164. FIG. 1H shows a block diagram for an electromagnetic treatment recipe delivery system with a radiating structure 120 powered by a voltage transformer 160 coupled to a digital-to-analog converter (DAC) 162 controlled by a computational control system 114 fed by utility power 150 and AC-to-DC transformer 154. In some instances, the converter 162 is an analog to digital converter. In some instances, the converter 162 is not used, not necessary, and/or not present. FIG. 1I shows a block diagram for an electromagnetic treatment recipe delivery system with a radiating structure 120 powered by a voltage transformer 160 coupled to a function generator 116 coupled to a timer 114 fed by a solar panel and battery 152. The function generator 116 may be pre-programmed with a recipe for creating a desired electromagnetic field from the radiating structure 120 and generated in accordance with a schedule programmed in timer 114.

1. Radiating Structures

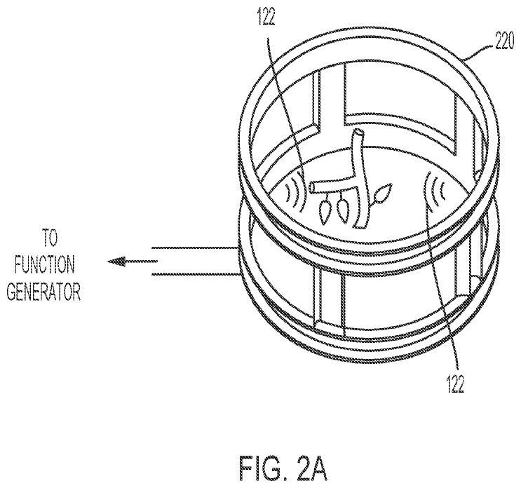

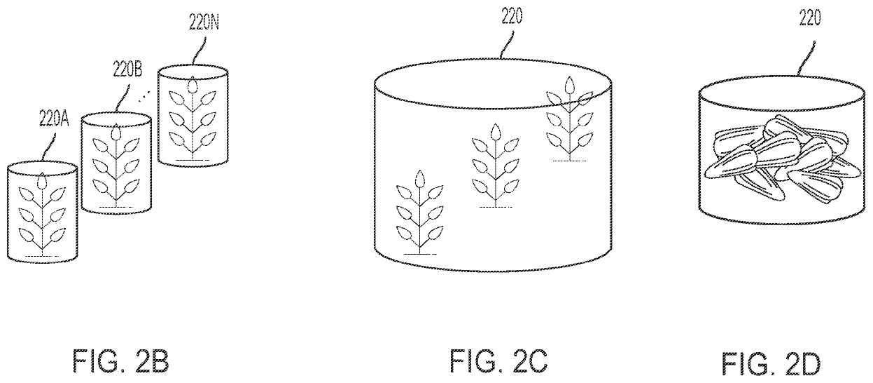

Radiating structure 120 shown in FIGS. 1A-1I can be any structure that delivers an electromagnetic field to the plants and/or seeds. FIGS. 2A-2D show example radiating structures involving coils. One example radiating structure is shown in FIG. 2A. FIG. 2A shows an example radiating structure for delivery of electromagnetic fields to plants and/or seeds according to some embodiments of the disclosure. A coil 220 may be coupled to radiate an electromagnetic field in accordance with an electromagnetic signal generated by the function generator. The coil 220 may be sized to fit around an individual plant and/or seeds, similar to protective fencing placed around trees or tomato plants. The coil 220 may be used to generate static magnetic fields upon the application of a static signal (e.g., DC or 0 Hz) signal by the function generator or oscillating magnetic fields upon the application of an oscillating signal (e.g., greater than 0 Hz). FIG. 2B shows an embodiment with coils 220A-N each arranged around a different one of a plurality of plants and/or seeds. FIG. 2C shows an embodiment with a coil 220 arranged around a plurality of plants and/or seeds. FIG. 2D shows an embodiment with a coil 220 arranged around seeds. In some embodiments, the coil 220 may provide a static DC magnetic field to offset the earth's magnetic field and an oscillating magnetic field at the same time. The coil 220 may be a single coil or a plurality of coils. The coil 220 may be arranged next to, in line with, in series with, in parallel to, perpendicular, or in other arrangements with other coils or with other radiating structures, such as wires, points, grids, mesh, plates, etc. In some instances, a coil can be formed by a continuous wire. In some instances, the coil can be a long continuous coil in the shape of a long tube.

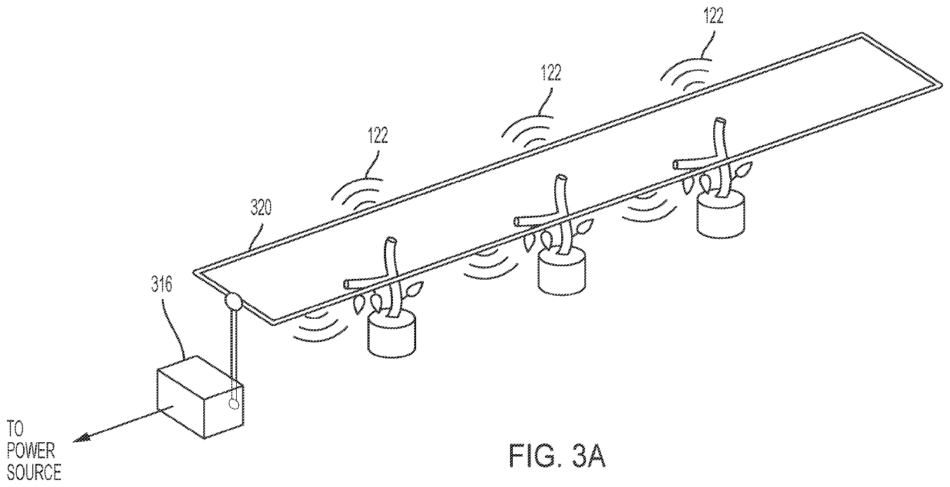

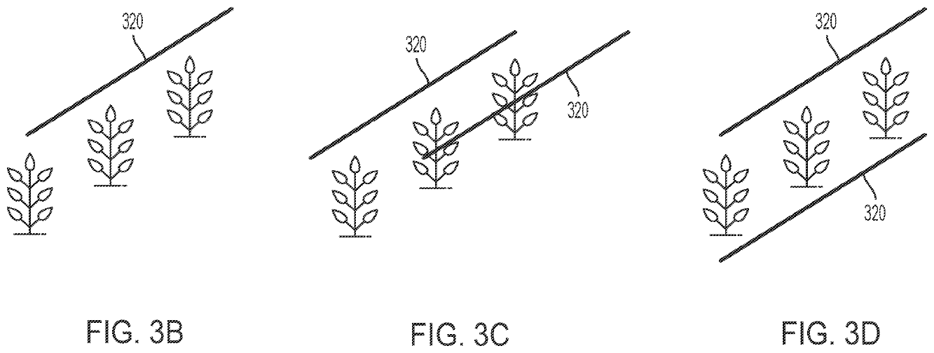

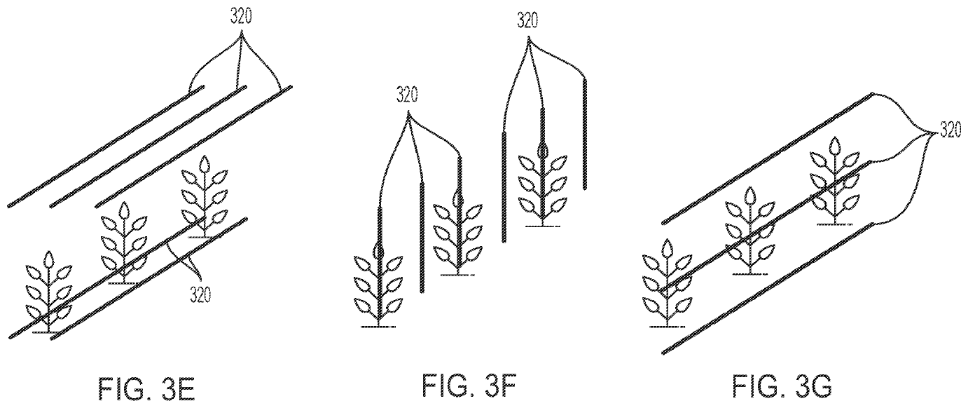

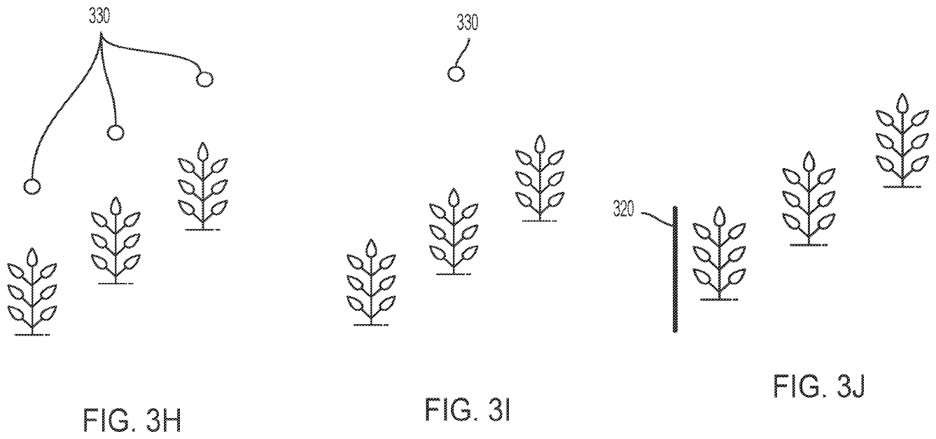

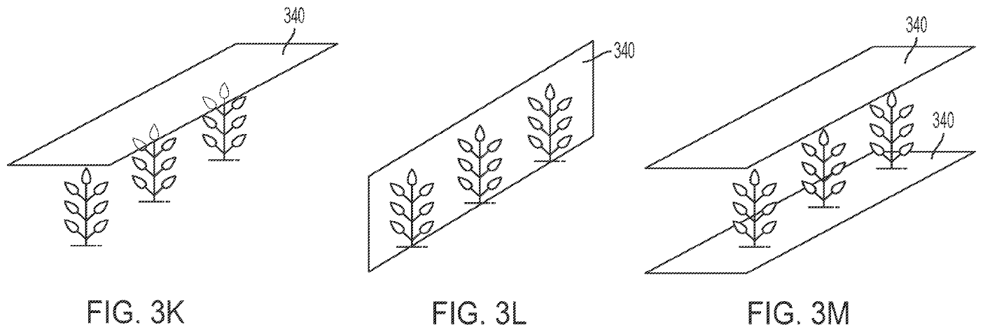

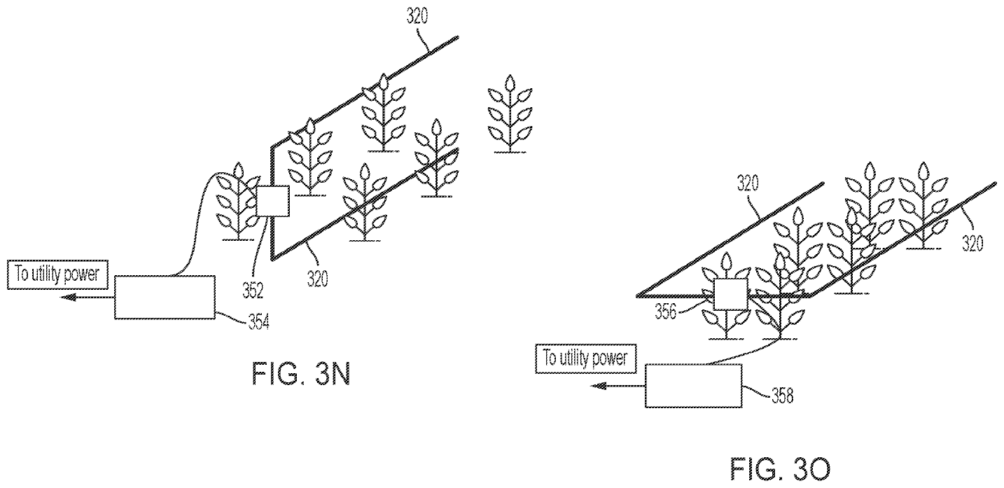

Other example radiating structures are shown in FIG. 3A-3O that include plate, grids, nets, meshes, point, wire and/or other configurations. FIG. 3A shows another example radiating structure for delivery of electromagnetic fields to plants and/or seeds according to some embodiments of the disclosure. Wires 320 are positioned in parallel over a container, row, or table of plants and/or seeds. The wires 320 are coupled to radiate an electromagnetic field in accordance with an electromagnetic signal generated by the electromagnetic treatment system 316. Multiple radiating structures of the same or different type may be coupled together to operate under control of a computational control system to support various sizes of nurseries. Other radiating structures for use in the system 100 include a structure positioned in close proximity, such as within 15 feet, to a plant and/or a seed, a structure comprising a metal or other radiating material, such as copper, galvanized steel, and/or or aluminum, a structure comprising a single or multiple line(s), wire(s), pipe(s), rod(s), coil(s), mesh(es), grid(s), plate(s), capacitor(s), point source antenna(s), chip antenna(s), spiral antenna(s), strip line antenna(s), grounding stake(s), tape(s), foil(s), and/or standard antenna(s), a structure comprising a plurality of electrically conductive material structures, structures that are at least in part parallel with each other, structures comprising parallel transmission lines, parallel wires, parallel pipes, parallel rods, parallel plate, parallel meshes, parallel grids, and/or parallel coils (e.g., Helmholtz coils), and/or structures positioned horizontally or vertically. In some embodiments, radiating structures may be placed in wires or pipes that are encapsulated in PVC or fiberglass pipes/tubes.

FIG. 3B shows a configuration with a wire 320 overhead, although the wire 320 could alternatively be below or within the height of the plant and/or seeds or the plant and/or seeds can surround the wire. FIG. 3C shows a configuration with parallel wires 320 side-by-side, which may be overhead, below, or within the height of the plant and/or seeds or the plant and/or seeds can surround the wires. FIG. 3D shows a configuration with two wires 320, one of which is over the plant and/or seeds and another of which is below the plant and/or seeds. FIG. 3E shows a configuration with multiple wires 320 overhead and/or below the plants and/or seeds. FIG. 3F shows a configuration with multiple wires 320 vertical to the ground and spread throughout the plants and/or seeds. FIG. 3G shows a configuration with multiple wires 320 spread throughout the height of the plants and/or seeds, and/or above and below the plant and/or seeds or the plant and/or seeds can surround the wires. FIG. 3H shows a configuration with multiple points 330 with each overhead, in the middle, or below individual plants and/or seeds or the plant and/or seeds can surround one or more of the points. The points can be a uniform size or a variety of sizes. FIG. 3I shows a configuration with a single point 330 arranged overhead, in the middle, or below multiple plants and/or seeds or the plant and/or seeds can surround one or more of the points. The points can be a uniform size or a variety of sizes. FIG. 3J shows a configuration with a single or multiple wires 320 arranged throughout a room or a field for treating multiple plants and/or seeds.

In some embodiments, the radiating structure may be arranged in a grid configuration, a mesh configuration, and/or may be a plate. FIG. 3K shows a configuration with a horizontal grid, mesh, and/or plate 340 overhead or below plants and/or seeds. FIG. 3L shows a configuration with one or more vertical grids, mesh, and/or plate 340 arranged through the plants and/or seeds or the plant and/or seeds can surround one or more of the grids, mesh, and/or plates. FIG. 3M shows a configuration with one or more horizontal grids, mesh, and/or plates 340 positioned overhead and below the plants and/or seeds, although some embodiments may also include vertical grids, mesh, and/or plates. The grids and mesh may include patterns similar to chicken wire, fence panels, grating, etc.

The radiating structure, such as wire, grid, mesh, and/or plate may be folded, bent, formed into shapes such as tubes, coils, cubes, rectangular tubes, cones, pyramids, spheres, etc., may be in multiple pieces, may be made with large openings or small openings formed by the radiating structures, such as wires, grid, mesh, and/or plate(s). In some instances, radiating structure may divide plants and/or seeds. In some instances, the radiating structure may surround the plants and/or seeds. A plurality of radiating structures can be arranged in parallel, perpendicular, or any other arrangement in relation to each other.

FIGS. 3N-3O show embodiments for connecting wire-based electromagnetic systems to utility power. In FIG. 3N, wires 320 are positioned over and below the plants and/or seeds. The wires 320 couple to electric box 352, which includes a high voltage transformer. The electric box 352 couples to electric box 354, which includes a programmable relay switch, two AC-to-DC transformers, a timer, a surge protector, and/or power splitters, configured such as in the embodiments shown in FIGS. 1A-1I. The electric box 354 is plugged into utility power or another power source to begin delivery of the electromagnetic field treatment to the plants and/or seeds. One recipe that can be implemented using FIG. 3N is a sub-continuous schedule involving the system being on for 2 hours, starting approximately 4 hours after plants and/or seeds are watered, with the treatment beginning six hours after perceived sunrise, for a duration of 53 days, with a target electric field strength of −5 Kv/m delivered from a transformer with a pulse ON time of 0.5 seconds and a pulse off time of 10 seconds, which has been shown to produce a 31% yield mass increase on flowering plants. In other embodiments for producing an electric field, the electric field may have a strength of −1,000 MV/m to 1,000 MV/m at a location where the electric field is produced. One recipe that can be implemented using FIG. 3O is a sub-continuous schedule involving the system being on for 3 hours, starting approximately 1 hour before plants are watered, with the treatment beginning 1 hour before perceived sunrise, for a duration of 53 days, with a target electric field strength of 15 Kv/m delivered from a transformer with a pulse ON time of 1 seconds and a pulse off time of 9 seconds, which has been shown to produce a 34% yield mass increase on flowering plants. In other embodiments for producing an electric field, the electric field may have a strength of −1,000 MV/m to 1,000 MV/m at a location where the electric field is produced.

In FIG. 3O, wires 320 are positioned in parallel side-by-side around plants and/or seeds. The wires 320 are coupled to electric box 356, which may include a balun. The electric box 356 is coupled to electric box 358, which may include a function generator, a fan, a surge protector, and/or power splitters, configured such as in the embodiments shown in FIGS. 1A-1I.

In some instances, the radiating structure, the whole system, or a portion of the system is movable during delivery of the electromagnetic treatment. As non-limiting examples, the system or the radiating structures can be mounted on a wheeled trailer and/or cart, on a vehicle such as a tractor, on a track and/or pulley system, on an elevator, etc.

2. Recipe Delivery

Referring back to the electromagnetic treatment recipe delivery system 100 of FIG. 1, the function generator produces electromagnetic signal 118 based on controls provided by computational system 114, which may be a processor, DSP, ASIC, or other electronic circuitry. A set of controls may be referred to as a recipe, and specify characteristics of the electromagnetic signal that the function generator 116 produces. These recipes can be entered through a control panel attached to the delivery system, such as to provide switches, knobs, graphical user interface display, and other input devices for manually programming parameters such as the time the system is on and treating the plants and/or seeds, field “strength” in terms of voltage, tesla, or dBm, target ion, etc. These recipes can be stored in memory 112 and recalled as desired, such as at intervals specified by the recipes. In some embodiments, the recipes are remotely delivered to the system 110 and stored in memory 112. In different embodiments, the memory 112 may store a recipe book of available recipes that can be read-out as needed or only a small set of recipes, such as those purchased by the user, are stored in the memory 112. In some embodiments, the recipe may be delivered through a network to the system 110 and deleted immediately after the recipe is used by the function generator. The recipes may represent valuable data that should be protected from unauthorized access or unauthorized modification.

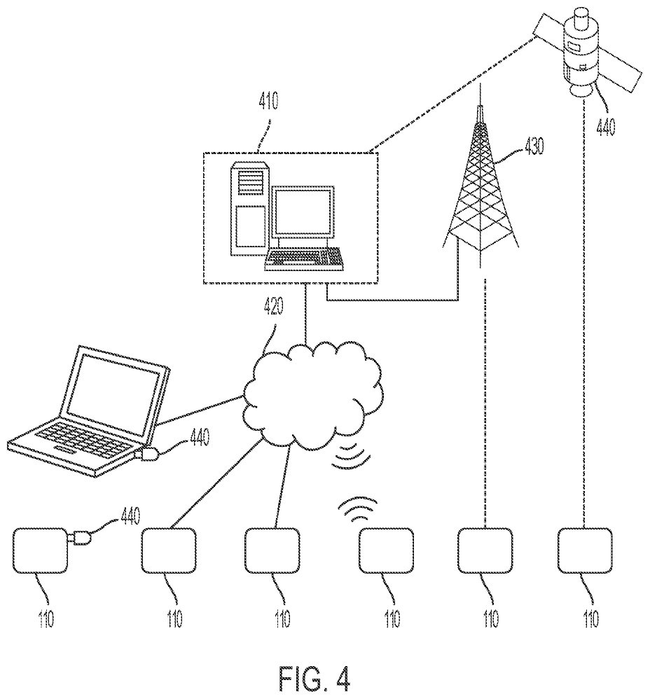

In some embodiments, the recipes may thus be maintained at a central facility from which the recipes or authorization codes to unlock certain recipes from a recipe book are provided to users of electromagnetic treatment recipe delivery systems. FIG. 4 shows a system for transmission of electromagnetic treatment recipes and/or authorization codes according to some embodiments of the disclosure. A server 410 may store and/or generate recipes and/or authorization codes for recipes. For example, the server 410 may maintain a recipe book from which individual recipes can be distributed to user systems 110. As another example, the server 410 may maintain a recipe book and distribute updates to recipes or recipe books stored on user systems 110. As a further example, the server 410 may store authorization codes that when provided to user systems 110 unlock certain recipes or certain functionality. As another example, the server 410 may generate and distribute authorization codes on demand based on other data, such as a unique serial number of a user system 110 or a key stored on a user system 110.

The server 410 may distribute information, including recipes or authorization codes, to the user systems 110 through a variety of techniques. In one example, the server 410 may connect to the user systems 110 through a public network 420, such as the Internet, through wired or wireless communications. In another example, the server 410 may connect to the user systems 110 through a proprietary radio transmission tower 430. In a further example, the server 410 may connect to the user systems 110 through satellite relay 440. In another example, the server 410 may connect to the user systems 110 through removable media, such as a USB data storage dongle 440. A user may use another computing device to obtain a secured recipe, code, key, or certificate that is loaded on the dongle 440 and coupled to the user system 110 for read-out.

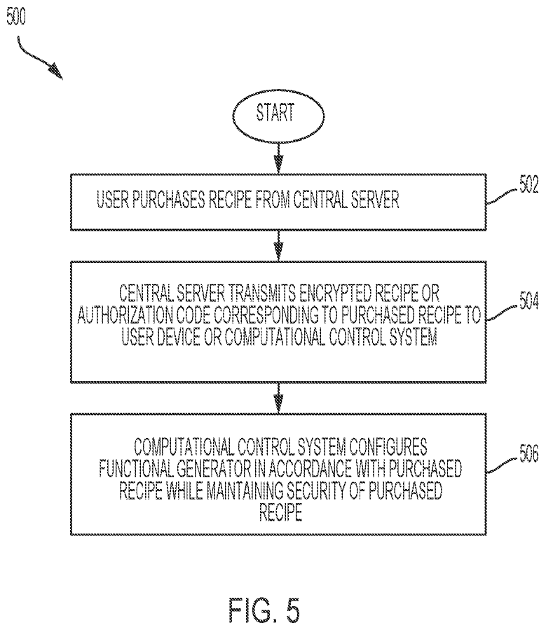

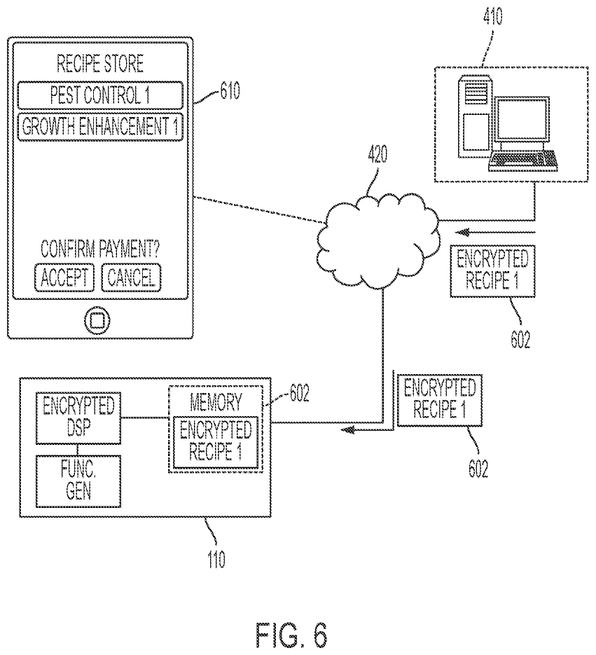

One example transaction for unlocking recipes in the electromagnetic treatment recipe delivery systems is shown in FIG. 5. FIG. 5 shows a flow chart for performing transactions involving electromagnetic treatment recipes according to some embodiments of the disclosure. A method 500 begins at step 502 with a user purchasing a recipe from a server. The method 500 is further illustrated in FIG. 6. FIG. 6 shows a system for secured transactions and encrypted transmission of electromagnetic treatment recipes and/or authorization codes according to some embodiments of the disclosure. A user may purchase recipes through a user interface that provides access to server 410. For example, a user's mobile device 610 may have a recipe store, similar to an app store, that provides menus to allow a user to select recipes, such as a “Pest Control 1” recipe and a “Growth Enhancement 1” recipe. The user's mobile device 610 may also facilitate payment for the recipe. Through communication with the server 410, the server 410 can confirm payment for the recipe and then arrange for transmission of the recipe to the user system 110. Other input from a user used for identifying a recipe may include selection by an automated server or user application, entry by a sales consultant, selection by phone or email system, and/or entry by a user on a web page form.

At step 504, the server 410 transmits the encrypted recipe or authorization code corresponding to the purchased recipe to a user device for loading to a computational system or directly to a computational system, such as the computational control system 114 of user system 110. An encrypted recipe 602 may be transmitted by the server 410 over the public network 420 to a user system 110. Example embodiments for delivery of the recipe may include transmission over the air (OTA), delivery of a recipe to a user or technician to manual enter the recipe in the plant and/or seed treatment system, and/or delivery of a file to be loaded into the plant and/or seed treatment system. The recipes can be monetized through business models such as software as a service (SaaS), a subscription model wherein the farm subscribes to a specific recipe and pays a monthly fee for use based on what they are growing and how much area they want treated, a lease model, and/or a direct sale model.

At block 506, the user system 110 decodes the recipe or code and configures the function generator 116 in accordance with the purchased recipe. Steps performed in the transmission of the recipe or code and performed in the storing and processing of data within the user system 110 may be performed in a manner to maintain security of the purchased recipe. For example, the recipe when stored in the memory 112 may be stored as encrypted data that cannot be read as plain text. The computational control system 114 of the user system 110 may be an encrypted digital signal processor (DSP) with a trusted platform module (TPM) that may assist in the reading and securing of the recipes. When desired or scheduled, the encrypted DSP decodes the recipe and provides control signals to the functional generator 116 to produce an electromagnetic signal. In some embodiments, the computational control system 114 may provide secure systems for logging number of uses of each recipe and transmitting the logged data back to the server 410. In one example, a schedule for the application of electromagnetic fields may be included in the recipe, where the exposure to electromagnetic fields is not intended to be continuous. In another example, a recipe may specify exposure to electromagnetic fields of different characteristics during different period of time during a day, a week, a month, or a year.

3. Multiple Radiating Structure Configurations

For large installations of plant nurseries that exceed the power output capability of a single user system 110, power amplifiers may be distributed throughout a location to power separate radiating structures within the location. For example, one function generator may be coupled to multiple power amplifiers and transformers throughout the location. As another example, a location may have four different grow rooms in one facility, wherein the plant and/or seed treatment system includes one computer, four amplifiers, and 64 transformers in one arrangement, or four computers, 64 amplifiers, and 64 transformers in another arrangement, or four computers, four amplifiers, and 16 transformers in yet another arrangement.

Another example is a farm with 4 different grow rooms in one facility. We might have 1 computer, 4 amplifiers, and 64 transformers in such an arrangement. Or we could have 4 computers, 64 amplifiers and 64 transformers. Another arrangement might include 4 computers, 4 amplifiers, and 16 transformers. Finally, multiple radiating structures may apply the same and/or different recipes to the same plant(s) and/or seed(s) depending on the desired outcomes.

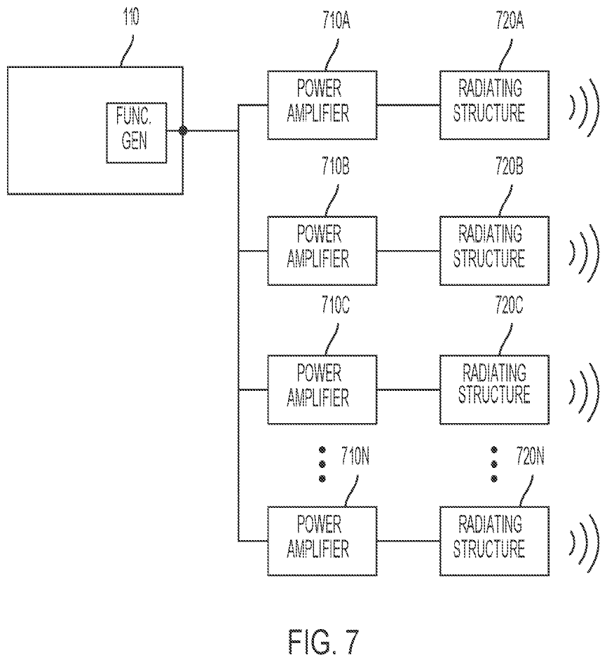

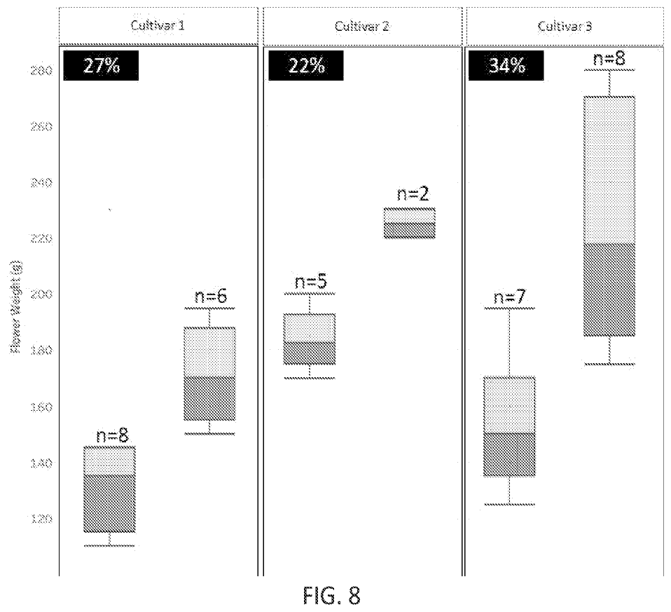

One example setup is shown in FIG. 7. FIG. 7 is a block diagram illustrating an electromagnetic treatment recipe delivery system involving multiple radiating structures according to some embodiments of the disclosure. A user system 100 includes a functional generator 116 that provides an output signal comprising an electromagnetic signal that when applied to a radiating structure produces an electromagnetic field conducive to plant and/or seed growth, pest deterrence, or other beneficial result. The electromagnetic signal may be a digital or analog signal supplied to a plurality of power amplifiers 710A-N that amplify the signal. The amplified signal is then applied to radiating structures 720A-N, respectively. In some embodiments, the power amplifiers 710A-N may include security measures that allow the power amplifiers 710A-N to be verified by the user system 110 before they can receive the electromagnetic signal from the functional generator. In some embodiments, this verification may be used by the functional generator to log an amount of use of a particular recipe, which can then be reported to the server 410 for billing or informational purposes.

### B. Treatment Recipe

Some or all of the electromagnetic plant and/or seed treatments described herein can be produced by any of the treatment systems described herein. The plant and/or seed treatments can include an electromagnetic field comprising a carrier frequency and a carrier waveform. In some instances, a carrier is not used. The electromagnetic field can be modulated with a modulating wave to produce a modulated electromagnetic field. In some instances, the electromagnetic fields are not modulated. The modulating wave can have a modulating frequency, a modulating waveform, and/or an amplitude modulating index. Not to be bound by theory, but it is believed that modifying one or more of the parameters disclosed herein may help increase the response of a plant's and/or seed's cellular processes to the electromagnetic treatment. Any of the electromagnetic parameters used herein may be positive or negative, and it is understood that electromagnetic parameters provided as a positive or negative number equally include both the positive and negative applications of that parameter.

1. Carrier Waveform:

Any carrier waveform can be used when a carrier wave is used. Carrier waveforms that can be used include, but are not limited to, static, pulsed, square, sine, triangular, sawtooth, damped pulse, rectangular, ramped, cardiogram, or amplitude varying.

2. Carrier Frequency:

The carrier frequency of the treatment can be any frequency from 0 Hz to 6 Ghz. The carrier frequency can be 0, 1, 2, 3, 4, 5, 6, 7, 8, 9, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990 Hz, or any range thereof or frequency there between. The carrier frequency can be 1, 2, 3, 4, 5, 6, 7, 8, 9, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990 KHz, or any range thereof or frequency there between. The carrier frequency can be 1, 2, 3, 4, 5, 6, 7, 8, 9, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990 MHz, or any range thereof or frequency there between. The carrier frequency can be 1, 2, 3, 4, 5, or 6 GHz, or any range thereof or frequency there between. The carrier frequency can be any range of the frequencies in this paragraph or frequency there between. In some instances, the carrier frequency is 0 Hz to 5.875 GHz, 0 to 200 Hz, 1 to 17 MHz, 1.4 to 15.1 MHz, 40 to 55 MHz, 45 to 50 MHz, 48 to 49 MHz, or 48.468 MHz. In some instances, the carrier frequency is a frequency with the Industrial, Scientific, and Medical (ISM) frequency bands. The ISM frequency bands can be frequencies designated as defined by the ITU Radio Regulations. The ISM frequency bands can include frequencies set aside for uses other than for telecommunications, though some of these frequencies have be used for telecommunications.

Not to be bound by theory, but it is believed that use of a carrier frequency that is dampened by tissue of the plant and/or seeds treated may help provide benefits to the plant and/or seeds. In some instances, the carrier frequency used is the frequency that is most dampened by plant and/or seed tissue. Additionally or alternatively, the electromagnetic treatments may stimulate or otherwise affect any class of molecules, including but not limited to proteins, carbohydrates, nucleic acids, lipids, and combination thereof, organelles inside, microorganisms inside, outside, associated with, attached to, in proximity to, plants on leaves, fruits, roots, seeds, etc. that affect the growth and vitality of the plant and/or seed.

3. Modulation Wave and Waveform:

The modulating wave, when used, can modulate the carrier wave's frequency and/or amplitude. In some instances, the modulating wave modulates the carrier's frequency. In some instances, the modulation wave modulates the carrier's amplitude. In some instances, the modulation wave modulates the carrier's frequency and amplitude. In other instances, the modulation may include amplitude modulation, frequency modulation, phase modulation, amplitude-shift keying, frequency-shift keying, phase-shift keying, and/or pulse width modulation.

Any modulation waveform can be used when a modulation wave is used. Modulation waveforms that can be used include, but are not limited to pulsed, square, sine, triangular, sawtooth, static, damped pulse, rectangular, ramped, cardiogram, or amplitude varying. In some instances, the modulation waveform is square.

4. Modulation Frequency:

The modulation wave frequency of the treatment can be any frequency. In some instances, the modulation frequency is from 0 Hz to 6 GHz. The modulation frequency can be 0, 1, 2, 3, 4, 5, 6, 7, 8, 9, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990 Hz, or any range thereof or frequency there between. The modulation frequency can be <1, 1, 2, 3, 4, 5, 6, 7, 8, 9, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990 KHz, or any range thereof or frequency there between. The modulation frequency can be <1, 1, 2, 3, 4, 5, 6, 7, 8, 9, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990 MHz, or any range thereof or frequency there between. The modulation frequency can be <1, 1, 2, 3, 4, 5, or 6 GHz, or any range thereof or frequency there between. The modulation frequency can be any range of the frequencies in this paragraph or frequency there between. In some instances, the modulation frequency is 0 to 200 Hz. In some instances, the modulation frequency is 188, 60, 50, 16, or 0 Hz. In some instances, the modulation frequency is 50 Hz.

5. Amplitude Modulation:

The amplitude of a carrier wave can be modified to provide an amplitude modulated wave. The amplitude of the carrier wave can be modified from 0% to 120%. The amplitude can be modified <1, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120%, or any range thereof or amplitude there between. In some instances, the modulation is in a square, sine, or sawtooth waveform pattern. In some instances, the amplitude is not modified. In some instances, the amplitude is modified from 5% to 50%. In some instances, the amplitude is modified 30%.

6. Magnetic Field Strength

The magnetic field strength of the treatment can be any magnetic field strength. In some instances, the magnetic field strength is from 0.001 micro Tesla to 100 mega Tesla or greater. The field strength can be 0, 1, 2, 3, 4, 5, 6, 7, 8, 9, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990 nano Tesla, or any range thereof or strength there between. The field strength can be 0, 1, 2, 3, 4, 5, 6, 7, 8, 9, 10, 20, 30, 40, 50, 60, 70, 80, 90, 100, 110, 120, 130, 140, 150, 160, 170, 180, 190,200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990 micro Tesla, or any range thereof or strength there between. The field strength can be 0, 1, 2, 3, 4, 5, 6, 7, 8, 9, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990 milli Tesla, or any range thereof or strength there between. The field strength can be 0, 1, 2, 3, 4, 5, 6, 7, 8, 9, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990 Tesla, or any range thereof or strength there between. The field strength can be 0, 1, 2, 3, 4, 5, 6, 7, 8, 9, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990 kilo Tesla, or any range thereof or strength there between. The field strength can be 0, 1, 2, 3, 4, 5, 6, 7, 8, 9, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990 mega Tesla, or any range thereof or strength there between. The magnetic field strength can be any range of the field strengths in this paragraph or field strengths there between. In some instances, the magnetic field strength is 0 to 250 micro Tesla. In some instances, the magnetic field strength is 1 to 9 milli Tesla.

7. Electric Field Strength

The electric field strength of the treatment can be any electric field strength. In some instances, the electric field strength is from 0.001 micro volts per meter to 100 mega volts per meter or greater. In some instances, the electric field strength is of positive polarity. In some instances, the electric field strength is of negative polarity. In some instances, the electric field strength switches between positive and negative polarity. The following strength examples shown are absolute values and each represent positive polarity or negative polarity electric field strengths. The field strength can be 0, 1, 2, 3, 4, 5, 6, 7, 8, 9, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340,350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990 micro volts per meter, or any range thereof or strength there between. The field strength can be 0, 1, 2, 3, 4, 5, 6, 7, 8, 9, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990 milli volts per meter, or any range thereof or strength there between. The field strength can be 0, 1, 2, 3, 4, 5, 6, 7, 8, 9, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990 volts per meter, or any range thereof or strength there between. The field strength can be 0, 1, 2, 3, 4, 5, 6, 7, 8, 9, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990 kilo volts per meter, or any range thereof or strength there between. The field strength can be 0, 1, 2, 3, 4, 5, 6, 7, 8, 9, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990 mega volts per meter, or any range thereof or strength there between. The electric field strength can be any range of the field strengths in this paragraph or field strengths there between. In some instances, the electric field strength is 0 to 1.5 volts per meter. In some instances, the electric field strength is 0 to 50 volts per meter. In some instances, the electric field strength is 0 to 5 kilo volts per meter. In some instances, the electric field strength is 10 to 15 kilo volts per meter. In some instances, the electric field strength is 200 to 300 kilo volts per meter.

8. Voltage

The voltage applied to the plant and/or seed can be any voltage. In some instances, the voltage is from 0.001 micro Volts to 100 mega Volts or greater. In some instances, the voltage is of positive polarity. In some instances, the voltage is of negative polarity. In some instances, the voltage switches between positive and negative polarity. The following strength examples shown are absolute values and represent example positive polarity and negative polarity voltages. The voltage can be 0, 1, 2, 3, 4, 5, 6, 7, 8, 9, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320,330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990 micro Volts, or any range thereof or voltage there between. The voltage can be 0, 1, 2, 3, 4, 5, 6, 7, 8, 9, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990 milli Volts, or any range thereof or voltage there between. The voltage can be 0, 1, 2, 3, 4, 5, 6, 7, 8, 9, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990 volts, or any range thereof or voltage there between. The voltage can be 0, 1, 2, 3, 4, 5, 6, 7, 8, 9, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390,400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990 kilo volts, or any range thereof or voltage there between. The voltage can be 0, 1, 2, 3, 4, 5, 6, 7, 8, 9, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990 mega volts, or any range thereof or voltage there between. The voltage can be any range of the field strengths in this paragraph or field strengths there between. In some instances, the voltage is 0 to 50 volts. In some instances, the voltage is 0 to 5 kilo volts. In some instances, the voltage is 10 to 15 kilo volts. In some instances, the voltage is 17 to 33 kilo volts.

9. Duration

The duration in which treatment is applied to the plant can be a variety of durations. In some instances, the duration is from 0.001 micro seconds to 3 months or greater. In some instances, the treatment is continuously applied. In some instances, the treatment is subcontinuously, periodically, or temporarily applied. In some instances, the treatment is routinely applied according to a timed schedule or algorithm. In some instances, the treatment is applied based on an external factor such as irrigation schedule, light intensity, or planting schedule. The following durations shown represent example durations. The duration can be 0, 1, 2, 3, 4, 5, 6, 7, 8, 9, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990 micro seconds, or any range thereof or time there between. The duration can be 0, 1, 2, 3, 4, 5, 6, 7, 8, 9, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320,330, 340, 350, 360,370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990 milliseconds, or any range thereof or time there between. The duration can be 0, 1, 2, 3, 4, 5, 6, 7, 8, 9, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340,350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990 seconds, or any range thereof or seconds there between. The duration can be 0, 1, 2, 3, 4, 5, 6, 7, 8, 9, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340,350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990 minutes, or any range thereof or minutes there between. The duration can be 0, 1, 2, 3, 4, 5, 6, 7, 8, 9, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990 hours, or any range thereof or hours there between. The duration can be 0, 1, 2, 3, 4, 5, 6, 7, 8, 9, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990 days, or any range thereof or days there between. The duration can be any range of the durations in this paragraph or durations there between. In some instances, the duration is 10 milliseconds. In some instances, the duration is 60 minutes. In some instances, the duration is 3 hours. In some instances, the duration is 56 days.

### C. Method of Use

The electromagnetic treatment recipes, methods of treatments, and systems and apparatuses to treat plants and/or seeds with said electromagnetic treatments disclosed herein have been found to increase and/or decrease the weight of at least a portion of the plant, yield of the plant, germination rate, germination timing, time to emergence of a coleoptile, time to emergence of a first true leaf, cold tolerance, membrane permeability, nutrient uptake, gene transcription, gene expression, cell growth, cell division, protein synthesis, latent heat flux, carbon assimilation, stomatal conductance, the chemical profile in at least a portion of the plant, the cannabinoid profile, the terpene profile, trichome content, the time required for harvest readiness, quantity of flowering sites, internode spacing, and/or repel and/or decrease the amount of pests on the plant and/or seed, as compared to a plant and/or seed that is not treated.

1. Plants

The plant treated can be any plant and/or seed, such as a crop plant, an ornamental plant, a medicinal plant, lumber trees, or a plant used for beneficial uses such as ground cover, reduction of soil erosion the receding or changing of shores or banks, providing shade or shelter, reintroduction or increasing the number of plants or plant species in an area, etc.

In some embodiments, the plant is selected from any plant of the kingdom Plantae. In embodiments, the plant belongs to the subkingdom Viridiplantae. In embodiments, the plant belongs to the infrakingdom Streptophta. In embodiments, the plant belongs to the superdivision Embryophyta. In embodiments, the plant belongs to the division Tracheophyta. In embodiments, the plant belongs to the subdivision Spermatophytina. In embodiments, the plant belongs to the class Magnoliopsida. In embodiments, the plant belongs to a superorder selected from Rosanae and Asteranae. In embodiments, the plant belongs to an order selected from Rosales, Brassicales Asterales, Vitales, and Solanales. In embodiments, the plant belongs to a family selected from Brassicaceae, Asteracae, Aracea, Vitacaea, Solanacaea, and Cannabaceae. In embodiments, the plant belongs to a genus selected from Humulus, Brassica, Eruca, Lactuca, Vitis, Solanum and Cannabis. In embodiments, the plant is selected from the species Humulus japonicus, Humulus lupulus, Lemna minor, Brassica rapa, Eruca vesicaria, Lactuca biennis, Lactuca canadensis, Lactuca floridana, Lactuca graminifolia, Lactuca hirsute, Lactuca indica, Lactuca ludoviciana, Lactuca X morssii, Lactuca sagilina, Lactuca sativa, Lactuca serriola, Lactuca terrae-novae, Lactuca virosa, Vitis acerifolia, Vitis aestivalis, Vitis amurensis, Vitis arizonica, Vitis X bourquina, Vitis californica, Vitis X champinii, Vitis cinerea, Vitis coriacea, Vitis X doaniana, Vitis girdiana, Vitis labrusca, Vitis X labruscana, Vitis monticola, Vitis mustangensis, Vitis X novae-angliae, Vitis palmata, Vitis riparia, Vitis rotundifolia, Vitis rupestris, Vitis shuttleworthii, Vitis tillifolia, Vitis vinifera, Vitis vulpina, Cannabis sativa, and Solanum lycopersicum. In embodiments, the plant is a cultivar or subspecies of any of the above referenced species. In embodiments, the plant is selected from any of the plants commonly referred to as lettuce, arugula, bok choy, tomato, cannabis, hemp, grape, hops, spinach, sunflower, canola, flax corn, rice, wheat, oat, barley, soybean, bean, pea, legume, chickpea, sorghum, sugar cane, sugar beet, cotton, potato, turnip, carrot, onion, cantaloupe, watermelon, blueberry, cherry, apple, pear, peach, cacti, date, fig, coconut, almond, walnut, pecan, cilantro, broccoli, cauliflower, zucchini, squash, pumpkin, duckweed, and mizuna, and any cultivars or subspecies thereof.

Any of the effects disclosed herein may apply to one or more plants and/or seeds. Specific, non-limiting examples of plants that aspects of the invention may apply to include hemp, cannabis, Cannabis sativa, Cannabis indica, Cannabis ruderalis, Zea mays, and Glycine max, or any related cultivars or subspecies thereof.

2. Pests

The electromagnetic treatment recipes, methods of treatments, and systems and apparatuses disclosed herein in some instances, can deter pests, repel pests, modify the behavior of pests, and/or even kill and/or decrease the fertility of pests. In some instances, the treatment may modify a plant and/or seed so that the plant and/or seed itself can deter pests, repel pests, modify the behavior of pests, and/or even kill and/or decrease the fertility of pests.

In some embodiments, the pest can include, but is not limited to, invertebrate pests such as insects, arthropods, mites, and nematodes, fungi, bacteria, animals, or disease causing organisms. Non-limiting examples of pest can include, but are not limited to Achatina fulica, Adelges tsugae, Agrilus planipennis, Ampullaria gigas, Bruchus rupfmanus, Callosobruchus maculatus, Cinara cupressi, Dendroctonus valensi, Eriosona lanigerum, Euglandina rosea, Hemiberlesia pilysophila, Hyphantria cunea, Incisitermes minor, Lehmannia valentiana, Linepithema humile, Liriomyza sativae, Nylanderia fulva, Opogona sacchari, Oracella acuta, Pheidole megacephala, Pomacea canaliculataI, Schislocerca americanaI, Sirex nocilloI, Solenopsis invicta, Solenopsis mandibularis, Trogoderma granariumI, Vespula vulgaris, Viteus vitifoliae, Wasmannia auropunctataI, Zabrotes subfasciatus, Callosobruchus Chinensis, Sitophilus zeamais, Tribolium castaneum, Epilachna vigintioctomaculata, Agriotes fuscicollis, Anomala rufocuprea, Leptinotarsa decemhneata, Diabrotica spp., Monochamus alternatus, Lissorhoptrus oryzophilus, Lymantria dispar, Malacosoma neustria, Pieris rapae, Spodoptera litura, Mamestra brassicae, Chilo suppressalis, Pyrausta nubilalis, Ephestia cautella, Adoxophyes orana, Carpocapsa pomonella, Galleria mellonella, Plutella maculipennis, Heliothis Phyllocnistis citrella, Nephotettix cincticeps, Nilaparvata lugens, Pseudococcus comstocki, Unaspis yanonensis, Myzus persicae, Aphis pomi, Aphis gossypii, Rhopalosiphum pseuddobrassicas, Stephanitis nashi, Nazara spp., Cimex leclularius, Trialeurodes vaporariorum, Psylla spp., Blatella germanica, Periplanela americana, Gryllotalpa africana, Locusta migratoria migratoriodes, Reticulitermes speratus, Coptotermes formosanus, Thrips palmi karny, Musaca domestica, Aedes aegypti, Hylemia platura, Culex piptens, Anopheles sinensis, Culex lrilaeniorhynchus, Tetranychus telarius, Panonychus citri, Aculops pelekassi, Tarsonemus spp., Meloidogyne incognita, Bursaphelenchus lignicolus mamiya et kiyohara, Aphelenchoides bessey, Heterodera glycines, Pratylenchus spp., etc. or any related species, such as a species within the same genus or family.

3. Timing

The treatments disclosed herein can be started, stopped, modified, paused, etc. based on a predetermined or programmable schedule and/or a trigger. In some instances, watering, weeding, fertilizing, calendar days, days of the week, time of the day or night, exposure to light, sensors, stage of a plant life, crop cycle, etc. can be used as a trigger. Stages of a plant life include seed, germination, growth, reproduction, pollination, spreading seed, fruiting, harvest, etc. In some instances, environmental changes can be a trigger, such as, but not limited to, air or ground temperature, rain, cloud cover, approaching storm, passage of a storm, change in electromagnetic field such as those that occur with storms, ion concentration, concentration of a chemical or compound, etc.

4. Location and Environmental Modifications

One or more treatment(s) can be applied to different portions of a plant and/or seed, or the surrounding environment (s), to produce a specific result. In a non-limiting example, two or more radiating structures may be simultaneously used on the lower and upper portions of the plant. In this non-limiting example, one recipe may be applied to the root system, to potentiate nutrient acquisition while the same or different recipe(s) may be simultaneously applied to the stem and leaves of the plant to increase cannabinoid production. Different portions of the plant can include, but are not limited to, any part of the root system, including course roots, fine roots, adventitious roots, and root hairs, and any part of the shoot system, including stems, leaves, branches, flowers, inflorescences, bark, internodes, or any other part or organ considered to be a part of the plant and/or seed. Said applications can further be applied to any part of the surrounding environment including the surrounding atmosphere, rhizosphere, water or nutrients that may come in contact with the plant and/or seed in order to alter the surrounding environment and/or environmental properties.

These and other non-limiting aspects of the present invention are discussed in further detail in the following sections.

### EXAMPLES

The present invention will be described in greater detail by way of specific examples. The following examples are offered for illustrative purposes only, and are not intended to limit the invention in any manner. Those of skill in the art will readily recognize a variety of noncritical parameters, which can be changed or modified to yield essentially the same results.

### Example 1

### Secondary Compounds

When applied to Cannabis sativa, L., electromagnetic treatments described in Table 1. increased the overall concentrations of both cannabinoids and terpenes. The following cannabinoids were measured: cannabidiol (CBD), cannabidiolic acid (CBDa), cannabidiolic acid (CBDa) cannabinol (CBN), tetrahydrocannabivarin (THCV), tetrahydrocannabivarin acid (THCVa), tetrahydrocannabinol (THC), tetrahydrocannabinolic acid (THCa), cannabichromene (CBC), cannabichromene (CBC), cannabichromenic acid (CBCa), cannabigerol (CBG), and cannabigerolic acid (CBGa). It is understood that certain traits of other cannabinoids, terpenes, and plant compounds are substantially similar to the cannabinoids and terpenes disclosed herein, and that said systems and treatments apply to additional cannabinoids, terpenes, and plant compounds, including but not limited to charged/uncharged variants, structural variants, and structurally or functionally related compounds. When the aforementioned cannabinoids were compared between eight (8) plants that received the electromagnetic treatment and eight (8) plants that did not receive the treatment, for a total of sixteen (16) genetically-identical clones from a cultivar, impacts were noted in overall cannabinoids, and in individual cannabinoids including tetrahydrocannabinol (THC), tetrahydrocannabinolic acid (THCa) and cannabichromenic acid (CBCa). See Table 2. The cannabidiolic acid (CBDa) and cannabigerol (CBG) concentrations decreased while the cannabinol (CBN) and tetrahydrocannabivann (THCV) were effectively unchanged. The increase in tetrahydrocannabinol (THC) and coinciding decrease in both cannabidiol (CBD) and cannabigerol (CBG) demonstrates the utility of this technology for altering the ratio of these molecules (which share a biosynthetic pathway). The overall impact in cannabinoids demonstrate the utility of this technology for impacting the overall amount of cannabinoids and the cannabinoid profile. These results demonstrate the utility of the described technology to increase and/or alter the relative abundance of cannabinoids, including tetrahydrocannabinol (THC), which are economically valuable due to their therapeutic and recreational applications. These results also demonstrate the utility of impacting the ratios of different cannabinoids and altering the overall cannabinoid profile of a cultivar, impacting the “entourage effect” or individual or group response(s) and experience(s) to the combined effects of multiple biologically active compounds sharing the same or related biochemical receptors.

TABLE 1
Treatment Recipe

| | |
|---|---|
| Exposure | continuous exposure for 47 days |
| Treatment Recipe | Carrier waveform: Sine |
| | Mod frequency: 16 Hz |
| | Mod waveform: Square |
| | Mod depth: 30% |
| | Voltage: 5 Vpp |

TABLE 2
Impact of electromagnetic treatments on cannabinoid
presence in Cannabis sativa L.

| Cannabinoid | Treated (%) | Not-Treated (%) | % Change |
|---|---|---|---|
| THCa | 23.459% | 22.401% | 4.72% |
| THC | 0.390% | 0.416% | −6.24% |
| CBDa | 0.080% | 0.082% | −2.10% |
| CBCa | 0.801% | 0.757% | 5.92% |
| CBGa | 0.720% | 0.765% | −5.95% |
| CBG | 0.317% | 0.360% | −12.16% |
| CBNa | 0.115% | 0.114% | 0.72% |
| THCVa | 0.146% | 0.145% | 0.46% |
| CBN (total*) | 0.095% | 0.095% | 0.00% |
| THCV (total*) | 0.123% | 0.123% | 0.00% |
| CBD (total*) | 0.065% | 0.069% | −5.45% |
| THC (total*) | 21.028% | 20.124% | 4.49% |
| CBC (total*) | 0.700% | 0.661% | 5.86% |
| CBG (total*) | 0.946% | 0.985% | −3.93% |

The electromagnetic treatments, when applied to the eight (8) genetically identical plants referenced above, resulted in a substantial increase in terpene concentrations relative to plants that did not receive electromagnetic treatments. Concentrations from the following terpenes were measured: α-Pinene, β-Pinene, β-Caryophyllene, Humulene, Limonene, Linalool, Camphene, and Myrcene. Concentrations of all of the aforementioned terpenes increased with the exception of Humulene, which decreased in concentration by four-point-two (4.2) percent. See Table 3. Increases in α-Pinene, β-Pinene, Limonene, linalool, Camphene, and Myrcene ranged from seventeen-point-nine (17.9) to thirty-three-point-nine (33.9) percent. Total terpene abundance was on average 10.1% higher in the plants that received the treatment compared to plants that did not receive the treatment. Camphene was expressed in detectable levels in five (5) of the eight (8) treated plants and only two (2) of the eight (8) plants that did not receive a treatment.

TABLE 3
Impact of electromagnetic treatments on
terpene presence in Cannabis sativa L.

| Terpene | Treated (ppm) | Not-Treated (ppm) | % Change |
|---|---|---|---|
| α-Pinene | 324.4 | 267.5 | 21.3% |
| β-Pinene | 733.8 | 547.9 | 33.9% |
| β-Caryophyllene | 12360.8 | 12054.9 | 2.5% |
| Humulene | 2800.5 | 2924.1 | −4.2% |
| Limonene | 3216.4 | 2574.8 | 24.9% |
| Linalool | 1929.5 | 1567.6 | 23.1% |
| Camphene | 156.0 | 132.4 | 17.9% |
| Myrcene | 4383.1 | 3596.8 | 21.9% |
| Total % | 2.6% | 2.4% | 10.1% |

In one experiment comparing 27 Cannabis sativa plants, the plant that received the electromagnetic treatment described in Table 4 exhibited a 27.05% total abundance of measured cannabinoids, compared to the average of 22.3% in plants that did not receive the treatment, resulting in 21.4% greater total cannabinoids measured in comparison to the average of plants that did not receive the treatment. In this case, the plant that received the electromagnetic treatment produced a greater amount of cannabinoids than all other plants, which is commercially desirable.

In the experiment comparing 27 Cannabis sativa plants, the plant that received the electromagnetic treatment described in Table 4 exhibited a 3.07% total abundance of measured terpenes, compared to the average of 2.37% in plants that did not receive the treatment, resulting in 29.5% greater total terpenes measured in comparison to the average of plants that did not receive the treatment. In this case, the plant that received the electromagnetic treatment produced a greater amount of terpenes than all other plants, which is commercially desirable.

TABLE 4
Treatment Recipe

| | |
|---|---|
| Exposure | Subcontinuous for 56 days |
| Treatment Recipe | Waveform: square |
| | Frequency: 100 mHz |
| | Duty cycle: 10% |
| | Voltage: negative 10 to negative 24.5 kV |

### Example 2

### Yield Mass

Electromagnetic treatments can increase and/or alter yield. When electromagnetic treatments described in Table 5 were applied to three (3) separate Cannabis sativa L. cultivars dried flower biomass yield increased by twenty-seven (27), twenty-three (23), and thirty-four (34) percent for each of the cultivars. See FIG. 8. Sample sizes were 8, 7, and 15 for cultivars 1, 2, and 3 respectively.

TABLE 5
Treatment Recipe

| | |
|---|---|
| Exposure | Subcontinuous for 63 days |
| Treatment Recipe | Waveform: square |
| | Frequency: 100 mHz |
| | Duty cycle: 10% |
| | Voltage: negative 10 to negative 24.5 kV |

### Example 3

### Harvest Index

Electromagnetic treatments can increase and/or alter harvest index. When electromagnetic treatments of Table 5 were applied to three (3) separate Cannabis sativa L. cultivars (FIG. 8) dried flower biomass yield increased by twenty-seven (27), twenty-two (22), and thirty-four (34) percent for each of the cultivars. The total above-ground portion of the plants increased in the same three cultivars by three (3), nine (9) and twelve (12) percent. See Table 6. The number of plants per the treatment and control groups were as follows: cultivar 1, six (6) treated and eight (8) control; cultivar 2, two (2) treated and five (5) control; and cultivar 3, eight (8) treated and seven (7) control. The greater increase of flower yield relative to biomass indicates an increase in harvest index which is an important agricultural metric.

TABLE 6
Impact of electromagnetic treatments on mass in Cannabis sativa L.

| | Yield in flower | Above-ground | Ratio of flower mass to |
|---|---|---|---|
| | mass (g) | mass (g) | above-ground mass |
| Cultivar 1 | | | |
| Treated | 174.17 | 1185.83 | 0.147 |
| Not-Treated | 137.50 | 1150.63 | 0.120 |
| % Change | 26.67% | 3.06% | 22.91% |
| Cultivar 2 | | | |
| Treated | 225.00 | 1257.50 | 0.179 |
| Not-Treated | 184.00 | 1154.00 | 0.159 |
| % Change | 22.28% | 8.97% | 12.22% |
| Cultivar 3 | | | |
| Treated | 214.38 | 1386.75 | 0.155 |
| Not-Treated | 160.00 | 1240.00 | 0.129 |
| % Change | 33.98% | 11.83% | 19.81% |

An electromagnetic recipe as described in Table 7, when applied to two (2) Cannabis sativa L. cultivars different from those previously discussed, demonstrated that electromagnetic treatments can lower and/or alter the ratio. See Table 8. The percent change (% change) indicates the difference between the treated and the control groups within each cultivar. There were five (5) individual plants in each of the treated and control groups for cultivar 4 and 12 individual plants in each of the treated and control groups for cultivar 5.

TABLE 7
Treatment Recipe

| | |
|---|---|
| Exposure, part A | continuous exposure for 52 days |
| Treatment Recipe, part A | Carrier waveform: Sine |
| | Mod frequency: 16 Hz |
| | Mod waveform: Square |
| | Mod depth: 30% |
| | Voltage: 5 Vpp |
| Exposure, part B | Subcontinuous for 52 days |
| Treatment Recipe, part B | Waveform: square |
| | Frequency: 100 mHz |
| | Duty cycle: 10% |
| | Voltage: negative 10 to negative 24.5 kV |

TABLE 8
Impact of electromagnetic treatments on mass in Cannabis sativa L.

| | Yield in flower | above-ground | Ratio of flower mass to |
|---|---|---|---|
| | mass (g) | mass (g) | above-ground mass |
| Cultivar 4 | | | |
| Treated | 327.00 | 2211.00 | 0.15 |
| Not-Treated | 356.00 | 2244.00 | 0.16 |
| % Change | −8.15 | −1.47 | −6.78 |
| Cultivar 5 | | | |
| Treated | 289.00 | 2308.00 | 0.13 |
| Not-Treated | 291.00 | 2233.00 | 0.13 |
| % Change | 3.36 | −0.69 | −3.91 |

### Example 4

### Acceleration of Maturation and Seed Pre-Treatment

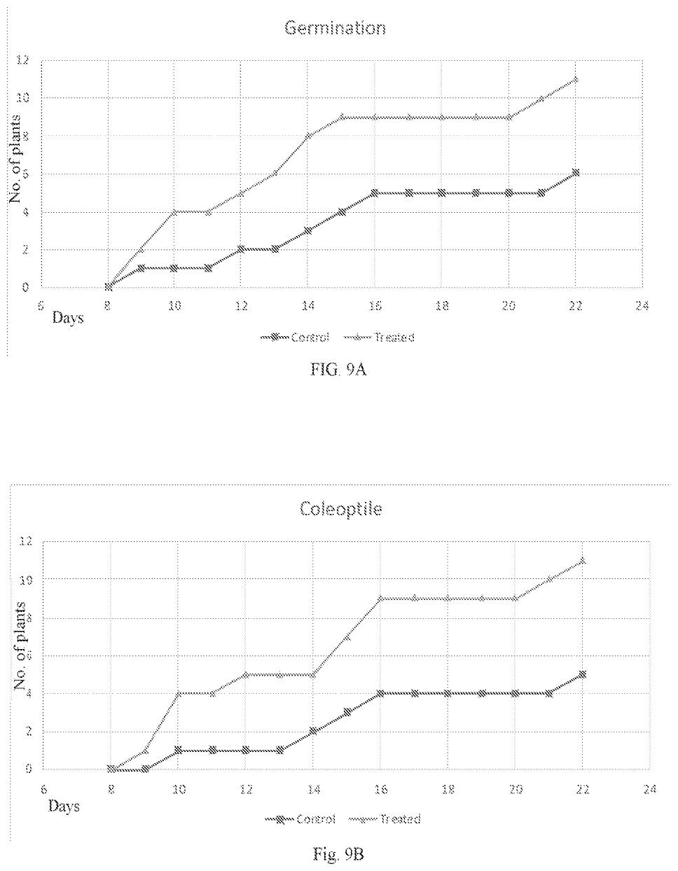

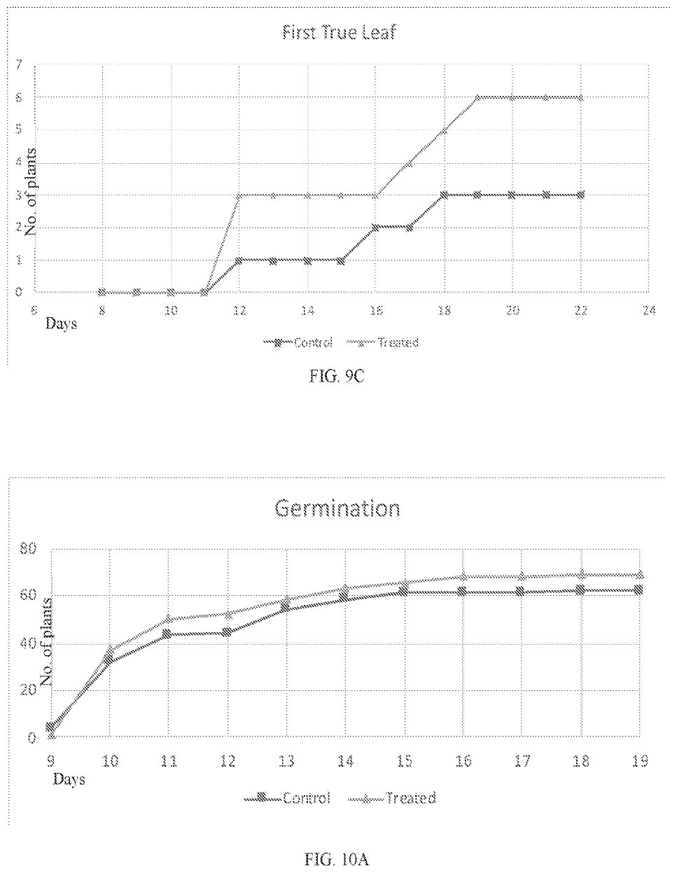

Electromagnetic treatment can improve and/or alter maturation, early vigor, and time elapsed between different points in lifecycle development. When an electromagnetic treatment as described in Table 9 was applied to Zea mays, pre-germination and pre-sowing, the time to reach germination (FIG. 9A), time to the emergence of the coleoptile (FIG. 9B) and time to the emergence of the first true leaf (FIG. 9C) was improved. The findings presented herein further demonstrate the utility of the described technology as a seed pre-treatment technology. There were twelve (12) individual plants in each of the treated and control groups.

TABLE 9
Treatment Recipe

| | |
|---|---|
| Exposure | 1 hour |
| Treatment Recipe | Waveform: Static |
| | Field Strength: 239 kV/m |
| | Voltage: 24.3 kV |

### Example 5

### Cold Stress Impact

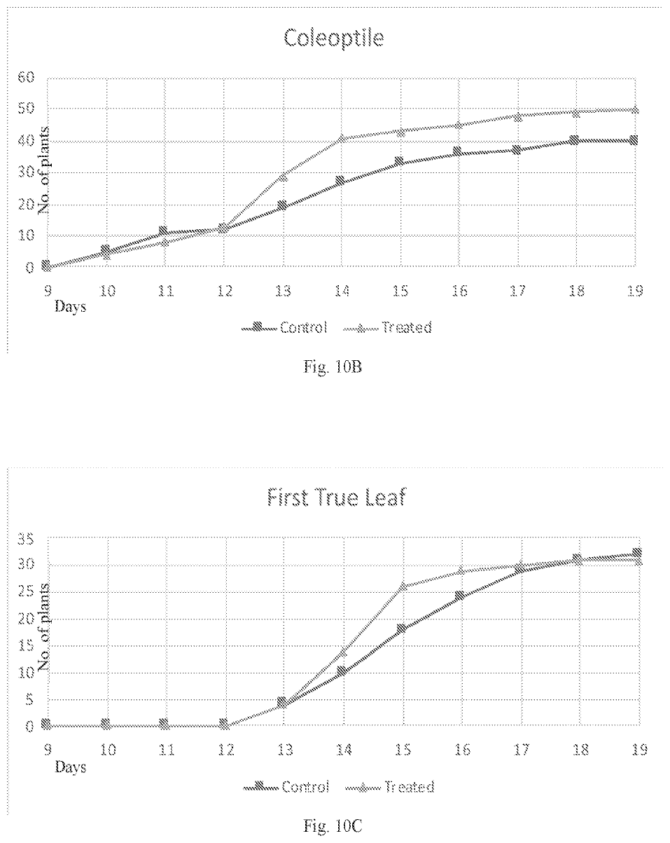

Further efficacy was observed when pre-treated seeds were exposed to cold stress of 5 degrees C. for 7 days post treatment in Zea Mays. When 94 seeds were pre-treated with the electromagnetic treatment as described in Table 10 and subsequent cold stress described herein, the treated seeds exhibited greater rates of germination (FIG. 10A), accelerated time to germination (FIG. 10A), accelerated coleoptile emergence (FIG. 10B), and accelerated true leaf emergence (FIG. 10C) compared to the 94 seeds that did not receive the electromagnetic treatment but did receive the same cold-stress.

TABLE 10
Treatment Recipe

| | |
|---|---|
| Exposure | 1 hour |
| Treatment Recipe | Waveform: Static |
| | Field strength: 3.8-4.2 mT |

### Example 6

### Yield Mass

Electromagnetic treatment can increase and/or alter yield. When an electromagnetic treatment as described in Table 11 were applied to Zea mays seed, biomass yield increased by five (5) percent. Sample size was approximately 2,890 plants each for treated and control.

TABLE 11
Treatment Recipe

| | |
|---|---|
| Exposure | 1 hour |
| Treatment Recipe | Waveform: Ramp (changing |
| | over time) |
| | Frequency: 16 Hz |
| | Voltage: 0 to negative 13.7 kV |

TABLE 12
Impact of electromagnetic treatments on Zea mays.

| | Average biomass yield, bushels per acre |
|---|---|
| Treated | 235.5 |
| Not-Treated | 224.8 |
| % Change | 5 |
| Bushel/Acre Change | 10.7 increase |

### Example 7

### Yield Mass

Electromagnetic treatment can increase and/or alter yield. When an electromagnetic treatment as described in Table 13 were applied to Zea mays seed, biomass yield increased by seven (7) percent. Sample size was approximately 2,890 plants each for treated and control.

TABLE 13
Treatment Recipe

| | |
|---|---|
| Exposure | 1 hour |
| Treatment Recipe | Waveform: Ramp Up |
| | Frequency: 24.254 Hz |
| | Voltage: 0 to negative 14.2 kV |

TABLE 14
Impact of electromagnetic treatments on Zea mays.

| | Average biomass yield, bushels per acre |
|---|---|
| Treated | 240.3 |
| Not-Treated | 224.8 |
| % Change | 7 |
| Bushel/Acre Change | 15.5 increase |

### Example 8

### Yield Mass

Electromagnetic treatment can increase and/or alter yield. When an electromagnetic treatment as described in Table 15 were applied to Zea mays seed, biomass yield increased by five (5) percent. Sample size was approximately 2,890 plants each for treated and control.

TABLE 15
Treatment Recipe

| | |
|---|---|
| Exposure | 1 hour |
| Treatment Recipe | Waveform: Static |
| | Field strength: 3.8 to 4.2 mT |

TABLE 16
Impact of electromagnetic treatments on Zea mays.

| | Average biomass yield, bushels per acre |
|---|---|
| Treated | 236.8 |
| Not-Treated | 224.8 |
| % Change | 5 |
| Bushel/Acre Change | 12.0 increase |

### Example 9

### Yield Mass

Electromagnetic treatment can increase and/or alter yield. When an electromagnetic treatment as described in Table 17 were applied to Eruca vesicaria (arugula) seed, biomass yield increased by five (5) percent. Sample size was 16 treated specimen trays and 16 control specimen trays.

TABLE 17
Treatment Recipe

| | |
|---|---|
| Exposure | 1 hour |
| Treatment Recipe | Waveform: Ramp |
| | Frequency: 16 Hz |
| | Voltage: 0 to negative 13.7 kV |

TABLE 18
Impact of electromagnetic treatments on Eruca vesicaria.

| | Average biomass yield in grams |
|---|---|
| Treated | 18.54 |
| Not-Treated | 17.69 |
| % Change | 5 |
| Mass Change | 0.85 increase |

### Example 10

### Yield Mass

Electromagnetic treatment can increase and/or alter yield. When an electromagnetic treatment as described in Table 19 were applied to Brassica rapa (mizuna) seed, biomass yield increased by seven (7) percent. Sample size was 16 treated specimen trays and 16 control specimen trays.

TABLE 19
Treatment Recipe

| | |
|---|---|
| Exposure | 1 hour |
| Treatment Recipe | Waveform: Ramp |
| | Frequency: 16 Hz |
| | Voltage: 0 to negative 13.7 kV |

TABLE 20
Impact of electromagnetic treatments on Brassica rapa.

| | Average biomass yield in grams |
|---|---|
| Treated | 17.30 |
| Not-Treated | 16.17 |
| % Change | 7 |
| Mass Change | 1.13 increase |

### Example 11

### Yield Mass

Electromagnetic treatment can increase and/or alter yield. When an electromagnetic treatment as described in Table 21 were applied to Zea mays seed, vegetative growth mass increased by nine (9) percent. Sample size was 140 treated specimen and 140 control specimen.

TABLE 21
Treatment Recipe

| | |
|---|---|
| Exposure | 1 hour |
| Treatment Recipe | Waveform: Ramp |
| | Frequency: 24.254 Hz |
| | Voltage: 0 to negative 7.2 kV |

TABLE 22
Impact of electromagnetic treatments on Zea mays.

| | Average biomass yield in grams |
|---|---|
| Treated | 1.024 |
| Not-Treated | 0.939 |
| % Change | 9 |
| Mass Change | 0.085 increase |

### Example 12

### Yield Mass

Electromagnetic treatment can increase and/or alter yield. When an electromagnetic treatment as described in Table 23 were applied to Zea mays seed, vegetative growth mass increased by ten (10) percent. Sample size was 140 treated specimen and 140 control specimen.

TABLE 23
Treatment Recipe

| | |
|---|---|
| Exposure | 1 hour |
| Treatment Recipe | Waveform: Ramp |
| | Frequency: 24.254 Hz |
| | Voltage: 0 to negative 7.4 kV |

TABLE 24
Impact of electromagnetic treatments on Zea mays.

| | Average biomass yield in grams |
|---|---|
| Treated | 1.030 |
| Not-Treated | 0.939 |
| % Change | 10 |
| Mass Change | 0.091 increase |

1. A seed treatment system configured to treat a seed with an electromagnetic field, the system comprising:
a function generator configured to provide a voltage and/or current used to generate the electromagnetic field; and
one or more radiating structure(s) coupled to the function generator and configured to produce the electromagnetic field for applying to the seed.

2. The seed treatment system of claim 1, further comprising a computational system configured to receive an input specifying parameters for controlling the function generator and to control the function generator to provide a voltage and/or current used to generate the electromagnetic field according to the input.

3. The seed treatment system of claim 2, wherein the computational system is configured to receive a recipe comprising the parameters for controlling the function generator and the parameters specifying a voltage and a optionally a modulating wave.

4. The seed treatment system of any one of claims 2 to 3, wherein the computational system is configured to receive more than one recipe comprising the parameters for controlling the function generator and the parameters specifying a carrier wave and a optionally a modulating wave, and control the function generator to generate any one or more of the more than one recipe.

5. The seed treatment system of any one of claims 2 to 4, wherein the computational system is configured to receive a schedule for applying the electromagnetic field to the seed.

6. The seed treatment system of claim 5, wherein the computational system is configured to change the electromagnetic field in accordance with the schedule.

7. The seed treatment system of any one of claims 2 to 6, wherein the computational system comprises a wireless communication component and is configured to wirelessly receive a recipe and/or schedule.

8. The seed treatment system of claim 7, wherein the recipe is encrypted.

9. The seed treatment system of any one of claims 1 to 8, wherein the function generator comprises a Software Defined Radio (SDR) or a transformer.

10. The seed treatment system of any one of claims 1 to 9, wherein the system is configured to produce an electromagnetic field.

11. The seed treatment system of any one of claims 1 to 10, wherein at least one radiating structure is positioned in close proximity to a seed.

12. The seed treatment system of any one of claims 1 to 10, wherein at least one radiating structure is positioned within 5 feet of a seed.

13. The seed treatment system of any one of claims 1 to 12, wherein at least one radiating structure comprises copper, galvanized steel, and/or or aluminum.

14. The seed treatment system of any one of claims 1 to 13, wherein at least one radiating structure comprises a transmission line, wire, pipe, rod, coil, capacitor, point source antenna, mesh, grid, grounding stake, tape, foil, plate, and/or standard antenna.

15. The seed treatment system of any one of claims 1 to 14, wherein the one or more radiating structure comprises a plurality of radiating structures.

16. The seed treatment system of claim 15, wherein at least two of the plurality of radiating structures are at least in part parallel with each other.

17. The seed treatment system of claim 16, wherein the at least two radiating structures comprise parallel transmission lines, parallel wires, parallel pipes, parallel rods, parallel meshes, parallel grids, parallel plates, and/or parallel coils.

18. The seed treatment system of claim 17, wherein the parallel coils are Helmholtz coils.

19. The seed treatment system of any one of claims 1 to 18, wherein at least one radiating structure is positioned horizontally or vertically.

20. The seed treatment system of any one of claims 1 to 19, wherein the system is capable of treating a seed located in the ground and/or before being planted.

21. The seed treatment system of any one of claims 1 to 20, wherein at least the radiating structure(s) is movable and capable of being moved during treatment of the seed by the electromagnetic field.

22. A method of treating a seed, the method comprising:
producing a treatment electromagnetic field using the seed treatment system of any one of claims 1 to 21; and
applying the treatment electromagnetic field to a seed.

23. A method for electromagnetic treatment of a seed, the method comprising:
producing an electromagnetic field; and
applying the electromagnetic field to a seed.

24. The method of claim 23, wherein producing the electromagnetic field comprises modulating a carrier frequency of 0 Hz to 5.875 GHz with a modulating wave to produce the electromagnetic field, wherein the modulating wave comprises a waveform with a modulating frequency of 0 Hz to 1 MHz, a modulating waveform, and/or an amplitude modulating index of 0% to 120%.

25. The method of any one of claims 23 to 24, wherein the electromagnetic field matches an ion cyclotron resonance frequency of calcium, potassium, magnesium, iron, copper, phosphate, phosphorous, and/or nitrogen during at least a portion of the treatment.

26. The method of claim 23, wherein the treatment is provided as a constant treatment or a treatment that is turned on and/or off or changed with watering cycles for the seed, set timing, an environmental change, and/or stage of the life of the seed.

27. The method of any one of claims 23 to 26, wherein the amplitude of the electromagnetic field and/or the modulated electromagnetic field produced an electromagnetic field configured to be dampened by tissue of the seed.

28. The method of claim 24, wherein modulating the electromagnetic field modulates the carrier amplitude and/or the carrier frequency.

29. The method of any one of claims 23 to 28, wherein the treatment comprises a magnetic field.

30. The method of any one of claims 23 to 29, wherein the treatment comprises a an electric field, wherein the electric field produced has a strength of −1,000 MV/m to 1,000 MV/m at a location where the electric field is produced.

31. The method of any one of claims 24 to 30, wherein the carrier waveform and/or a modulating waveform is static, pulsed, square, sine, triangular, sawtooth, damped pulse, rectangular, ramped, cardiogram, or amplitude varying, or any combination thereof.

32. The method of any one of claims 23 to 31, wherein the electromagnetic field produced has a strength of at least −110 dBm to at least 20 dBm at a location where the electromagnetic field is produced.

33. The method of any one of claims 24 to 32, wherein the method further comprises modulating strength of the modulated electromagnetic field.

34. The method of any one of claims 23 to 33, wherein the treatment is applied to a seed for 1 microsecond to 1440 minutes per day.

35. The method of any one of claims 23 to 34, wherein the treatment is applied to a seed for at least one minute to 1 day.

36. The method of any one of claims claim 23 to 35, wherein the electromagnetic field is produced by at least one of the radiating structure(s).

37. The method of claim 36, wherein at least one radiating structure is positioned in close proximity to the seed.

38. The method of claim 36, wherein at least one radiating structure is positioned within 5 feet of the seed.

39. The method of claim 36, wherein at least one radiating structure is positioned within 1 foot of the seed.

40. The method of any one of claims 36 to 39, wherein at least one radiating structure comprises a transmission line, wire, pipe, coil, rod, capacitor, point source antenna, mesh, grid, grounding stake, tape, foil, plate, and/or standard antenna.

41. The method of any one of claims 36 to 40, wherein the at least one radiating structure comprises a plurality of radiating structures.

42. The method of claim 41, wherein at least two of the plurality of radiating structures are at least in part parallel with each other.

43. The method of claim 42, wherein the at least two radiating structures comprise parallel transmission lines, parallel wires, parallel pipes, parallel rods, parallel coils, parallel antenna, parallel wire meshes, parallel wire grids, parallel grounding stakes, parallel tapes, parallel foils, and/or parallel plates.

44. The method of claim 43, wherein the parallel coils are Helmholtz coils.

45. The method of any one of claims 36 to 44, wherein at least one radiating structure is positioned horizontally or vertically.

46. The method of any one of claims 23 to 45, wherein the electromagnetic field mimics a change in the ambient electromagnetic field due to a storm.

47. The method of any one of claims 23 to 46, wherein the method modifies weight of at least a portion of a plant that grows from the seed, yield of the plant, germination rate, germination timing, time to emergence of a coleoptile, time to emergence of a first true leaf, cold tolerance, membrane permeability, nutrient uptake, gene transcription, gene expression, cell growth, cell division, protein synthesis, latent heat flux, carbon assimilation, stomatal conductance, the chemical profile in at least a portion of the plant and/or the seed, the time required for harvest readiness, quantity of flowering sites, internode spacing, and/or repel and/or decrease the amount of pests on the plant and/or seed, as compared to a seed that is not treated and/or a plant from a seed that is not treated.

48. The method of any one of claims 23 to 47, wherein the treatment is applied a synthetic seed.

49. The method of any one of claims 23 to 48, wherein the seed belongs to a kingdom Plantae.

50. The method of claim 49, wherein the seed belongs to a subkingdom Viridiplantae or any cultivar or subspecies thereof.

51. The method of claim 49, wherein the seed belongs to a infrakingdom Streptophta or any cultivar or subspecies thereof.

52. The method of claim 49, wherein the seed belongs to a superdivision Embryophyta or any cultivar or subspecies thereof.

53. The method of claim 49, wherein the seed belongs to a division Tracheophyta or any cultivar or subspecies thereof.

54. The method of claim 49, wherein the seed belongs to a subdivision Spermatophytina or any cultivar or subspecies thereof.

55. The method of claim 49, wherein the seed belongs to a class Magnoliopsida or any cultivar or subspecies thereof.

56. The method of claim 49, wherein the seed belongs to a superorder selected from Rosanae and Asteranae, or any cultivar or subspecies thereof.

57. The method of claim 49, wherein the seed belongs to an order selected from Rosales, Brassicales, Asterales, Vitales, and Solanales or any cultivar or subspecies thereof.

58. The method of claim 49, wherein the seed belongs to a family selected from Brassicaceae, Asteracae, Vitacaea, Cannabaceae, and Solanacaea or any cultivar or subspecies thereof.

59. The method of claim 49, wherein the seed belongs to a genus selected from Humulus, Brassica, Eruca, Lactuca, Cannabis, Vitis, and Solanum or any cultivar or subspecies thereof.

60. The method of claim 49, wherein the seed belongs to a species Humulus japonicus, Humulus lupulus, Cannabis sativa, Cannabis indica, Cannabis ruderalis, Brassica rapa, Eruca vesicaria, Lactuca biennis, Lactuca canadensis, Lactuca floridana, Lactuca graminifolia, Lactuca hirsute, Lactuca indica, Lactuca ludoviciana, Lactuca X morssii, Lactuca sagilina, Lactuca sativa, Lactuca serriola, Lactuca terrae-novae, Lactuca virosa, Vitis acerifolia, Vitis aestivalis, Vitis amurensis, Vitis arizonica, Vitis X bourquina, Vitis californica, Vitis X champinii, Vitis cinerea, Vitis coriacea, Vitis X doaniana, Vitis girdiana, Vitis labrusca, Vitis X labruscana, Vitis monticola, Vitis mustangensis, Vitis X novae-angliae, Vitis palmata, Vitis riparia, Vitis rotundifolia, Vitis rupestris, Vitis shuttleworthii, Vitis tillifolia, Vitis vinifera, Vitis vulpina, and Solanum lycopersicum, or any cultivar or subspecies thereof.

61. The method of claim 49, wherein the seed is a lettuce, arugula, bok choy, tomato, grape, hops, hemp, cannabis, corn, or mizuna, or any cultivar or subspecies thereof.

62. The method of claim 49, wherein the seed is spinach, sunflower, canola, flax corn, rice, wheat, oat, barley, soybean, bean, pea, legume, chickpea, sorghum, sugar cane, sugar beet, cotton, potato, turnip, carrot, onion, cantaloupe, watermelon, blueberry, cherry, apple, pear, peach, cacti, date, fig, coconut, almond, walnut, pecan, cilantro, broccoli, cauliflower, zucchini, squash, pumpkin, or any cultivar or subspecies thereof.

63. The method of claim 49, wherein the seed is a tomato plant, a lettuce plant, a strawberry plant, a saffron plant, or a grape plant.

64. The method of any one of claims 23 to 63, wherein
the system uses a voltage of 24.3 kV to generate the electromagnetic field,
the electromagnetic field comprises a static waveform with a field strength of 239 kV/m, and
wherein time to reach germination, time to emergence of a coleoptile, and/or time to emergence of a first true leaf is decreased as compared to a seed not treated by the method.

65. The method of claim 64, wherein the seed is a Zea mays seed.

66. The method of any one of claims 64 to 65, wherein the electromagnetic field is applied to the seed for at least 30 minutes.

67. The method of any one of claims 64 to 66, wherein the electromagnetic field is applied to the seed for 30 minutes to 3 hours.

68. The method of any one of claims 23 to 63, wherein
the electromagnetic field comprises a static waveform with a field strength of 3.8 to 4.2 millitesla, and
wherein time to reach germination, time to emergence of a coleoptile, and/or time to emergence of a first true leaf is decreased as compared to a seed not treated by the method.

69. The method of claim 68, wherein the seed is a Zea mays seed.

70. The method of any one of claims 68 to 69, wherein the electromagnetic field is applied to the seed for at least 30 minutes.

71. The method of any one of claims 68 to 70, wherein the electromagnetic field is applied to the seed for 30 minutes to 3 hours.

72. The method of any one of claims 68 to 71, wherein the seed is exposed to cold stress after the electromagnetic treatment.

73. The method of any one of claims 23 to 63, wherein
the system uses a voltage that is increased and/or decreased over time by a magnitude of at least 5 kV to generate the electromagnetic field,
the electromagnetic field has a frequency of 16 Hz or 24.254 Hz, and
wherein biomass yield of the plant produced from the seed is increased as compared to a seed not treated by the method.

74. The method of claim 73, wherein the voltage is increased or decreased by at least 7.2 kV, 7.4 kV, 13.7 kV, or 14.2 kV.

75. The method of any one of claims 73 to 74, wherein the voltage is increased or decreased from 0 V.

76. The method of any one of claims 73 to 75, wherein the voltage is changed over time from 0 V to negative 7.2 kV, negative 7.4 kV, negative 13.7 kV, or negative 14.2 kV.

77. The method of any one of claims 73 to 76, wherein the seed is a Zea mays seed, a Eruca vesicaria seed, or a Brassica rapa seed.

78. The method of any one of claims 73 to 77, wherein the electromagnetic field is applied to the seed for at least 30 minutes.

79. The method of any one of claims 73 to 78, wherein the electromagnetic field is applied to the seed for 30 minutes to 3 hours.

80. The method of any one of claims 23 to 63, wherein
the system uses a static waveform,
the electromagnetic field has a field strength of 3.8 to 4.2 millitesla, and
wherein biomass yield of the plant produced from the seed is increased as compared to a seed not treated by the method.

81. The method of claim 80, wherein the seed is a Zea mays seed.

82. The method of any one of claims 80 to 81, wherein the electromagnetic field is applied to the seed for at least 30 minutes.

83. The method of any one of claims 80 to 82, wherein the electromagnetic field is applied to the seed for 30 minutes to 3 hours.

84. The method of any one of claims 23 to 83, wherein the total consumption of energy to produce the modulated electromagnetic field is 1000 watts/100 ft² or less, preferably 100 watts/100 ft² or less, or more preferably 75 watts/100 ft² to 50 watts/100 ft², or more preferably 40 watts/100 ft² to 60 watts/100 ft².

85. The method of any one of claims 23 to 84, further comprising producing the modulated electromagnetic field by the plant treatment system of any one of claims 1 to 21.

86. A whole plant treatment system configured to treat a whole plant with an electromagnetic field, the system comprising:
a function generator configured to provide a voltage and/or current used to generate the electromagnetic field; and
one or more radiating structure(s) coupled to the function generator and configured to produce the electromagnetic field for applying to the whole plant.

87. The whole plant treatment system of claim 86, further comprising a computational system configured to receive an input specifying parameters for controlling the function generator and to control the function generator to provide a voltage and/or current used to generate the electromagnetic field according to the input.

88. The whole plant treatment system of claim 87, wherein the computational system is configured to receive a recipe comprising the parameters for controlling the function generator and the parameters specifying a voltage and a optionally a modulating wave.

89. The whole plant treatment system of any one of claims 87 to 88, wherein the computational system is configured to receive more than one recipe comprising the parameters for controlling the function generator and the parameters specifying a carrier wave and a optionally a modulating wave, and control the function generator to generate any one or more of the more than one recipe.

90. The whole plant treatment system of any one of claims 87 to 89, wherein the computational system is configured to receive a schedule for applying the electromagnetic field to the whole plant.

91. The whole plant treatment system of claim 90, wherein the computational system is configured to change the electromagnetic field in accordance with the schedule.

92. The whole plant treatment system of any one of claims 87 to 91, wherein the computational system comprises a wireless communication component and is configured to wirelessly receive a recipe and/or schedule.

93. The whole plant treatment system of claim 92, wherein the recipe is encrypted.

94. The whole plant treatment system of any one of claims 86 to 93, wherein the function generator comprises a Software Defined Radio (SDR) or a transformer.

95. The whole plant treatment system of any one of claims 86 to 94, wherein the system is configured to produce an electromagnetic field.

96. The whole plant treatment system of any one of claims 86 to 95, wherein at least one radiating structure is positioned in close proximity to a whole plant.

97. The whole plant treatment system of any one of claims 86 to 96, wherein at least one radiating structure is positioned within 15 feet of a whole plant.

98. The whole plant treatment system of any one of claims 86 to 97, wherein at least one radiating structure comprises copper, galvanized steel, and/or or aluminum.

99. The whole plant treatment system of any one of claims 86 to 98, wherein at least one radiating structure comprises a transmission line, wire, pipe, rod, coil, capacitor, point source antenna, mesh, grid, grounding stake, tape, foil, plate, and/or standard antenna.

100. The whole plant treatment system of any one of claims 86 to 99, wherein the one or more radiating structure comprises a plurality of radiating structures.

101. The whole plant treatment system of claim 100, wherein at least two of the plurality of radiating structures are at least in part parallel with each other.

102. The whole plant treatment system of claim 101, wherein the at least two radiating structures comprise parallel transmission lines, parallel wires, parallel pipes, parallel rods, parallel meshes, parallel grids, parallel plates, and/or parallel coils.

103. The whole plant treatment system of claim 102, wherein the parallel coils are Helmholtz coils.

104. The whole plant treatment system of any one of claims 86 to 103, wherein at least one radiating structure is positioned horizontally or vertically.

105. The whole plant treatment system of any one of claims 86 to 104, wherein the system is capable of treating a whole plant planted in the ground.

106. The whole plant treatment system of any one of claims 86 to 105, wherein at least the radiating structure(s) is movable and capable of being moved during treatment of the whole plant by the electromagnetic field.

107. A method of treating a whole plant, the method comprising:
producing a treatment electromagnetic field using the whole plant treatment system of any one of claims 86 to 106; and
applying the treatment electromagnetic field to a whole plant.

108. A method for electromagnetic treatment of a whole plant, the method comprising:
producing an electromagnetic field; and
applying the electromagnetic field to a whole plant.

109. The method of claim 108, wherein producing the electromagnetic field comprises modulating a carrier frequency of 0 Hz to 5.875 GHz with a modulating wave to produce the electromagnetic field, wherein the modulating wave comprises a waveform with a modulating frequency of 0 Hz to 1 MHz, a modulating waveform, and/or an amplitude modulating index of 0% to 120%.

110. The method of any one of claims 108 to 109, wherein the electromagnetic field matches an ion cyclotron resonance frequency of calcium, potassium, magnesium, iron, copper, phosphate, phosphorous, and/or nitrogen during at least a portion of the treatment.

111. The method of claim 108, wherein the treatment is provided as a constant treatment or a treatment that is turned on and/or off or changed with watering cycles for the whole plant, set timing, an environmental change, and/or stage of the life of the plant.

112. The method of claim 109, wherein the amplitude of the electromagnetic field and/or the modulated electromagnetic field produced an electromagnetic field configured to be dampened by tissue of the plant.

113. The method of claim 109, wherein modulating the electromagnetic field modulates the carrier amplitude and/or the carrier frequency.

114. The method of any one of claims 108 to 113, wherein the treatment comprises a magnetic field.

115. The method of any one of claims 108 to 114, wherein the treatment comprises a an electric field, wherein the electric field produced has a strength of −1,000 MV/m to 1,000 MV/m at a location where the electric field is produced.

116. The method of any one of claims 109 to 115, wherein the carrier waveform and/or a modulating waveform is static, pulsed, square, sine, triangular, sawtooth, damped pulse, rectangular, ramped, cardiogram, or amplitude varying, or any combination thereof.

117. The method of any one of claims 108 to 116, wherein the electromagnetic field produced has a strength of at least −110 dBm to at least 20 dBm at a location where the electromagnetic field is produced.

118. The method of any one of claims 109 to 117, wherein the method further comprises modulating strength of the modulated electromagnetic field.

119. The method of any one of claims 108 to 118, wherein the treatment is applied to a whole plant for 1 microsecond to 1440 minutes per day.

120. The method of any one of claims 108 to 119, wherein the treatment is applied to a whole plant for at least one day to 12 months.

121. The method of any one of claims claim 108 to 120, wherein the electromagnetic field is produced by at least one of the radiating structure(s).

122. The method of claim 121, wherein at least one radiating structure is positioned in close proximity to the whole plant.

123. The method of claim 121, wherein at least one radiating structure is positioned within 15 feet of the whole plant.

124. The method of claim 121, wherein at least one radiating structure is positioned within 3 feet of the whole plant.

125. The method of any one of claims 121 to 124, wherein at least one radiating structure comprises a transmission line, wire, pipe, coil, rod, capacitor, point source antenna, mesh, grid, grounding stake, tape, foil, plate, and/or standard antenna.

126. The method of any one of claims 121 to 125, wherein the at least one radiating structure comprises a plurality of radiating structures.

127. The method of claim 126, wherein at least two of the plurality of radiating structures are at least in part parallel with each other.

128. The method of claim 127, wherein the at least two radiating structures comprise parallel transmission lines, parallel wires, parallel pipes, parallel rods, parallel coils, parallel antenna, parallel wire meshes, parallel wire grids, parallel grounding stakes, parallel tapes, parallel foils, and/or parallel plates.

129. The method of claim 128, wherein the parallel coils are Helmholtz coils.

130. The method of any one of claims 121 to 129, wherein at least one radiating structure is positioned horizontally or vertically.

131. The method of any one of claims 108 to 130, wherein the electromagnetic field mimics a change in the ambient electromagnetic field due to a storm.

132. The method of any one of claims 108 to 131, wherein the method modifies weight of at least a portion of a plant, yield of the plant, germination rate, germination timing, time to emergence of a coleoptile, time to emergence of a first true leaf, cold tolerance, membrane permeability, nutrient uptake, gene transcription, gene expression, cell growth, cell division, protein synthesis, latent heat flux, carbon assimilation, stomatal conductance, the chemical profile in at least a portion of the plant, the time required for harvest readiness, quantity of flowering sites, internode spacing, and/or repel and/or decrease the amount of pests on the plant, as compared to a plant that is not treated.

133. The method of any one of claims 108 to 132, wherein the treatment is applied a plant when the plant is a cutting, a seedling, a mature plant, a plant in a flowering stage, a plant in a vegetative stage, and/or a plant in a fruiting stage.

134. The method of any one of claims 108 to 133, wherein the plant belongs to a kingdom Plantae.

135. The method of claim 134, wherein the plant belongs to a subkingdom Viridiplantae or any cultivar or subspecies thereof.

136. The method of claim 134, wherein the plant belongs to a infrakingdom Streptophta or any cultivar or subspecies thereof.

137. The method of claim 134, wherein the plant belongs to a superdivision Embryophyta or any cultivar or subspecies thereof.

138. The method of claim 134, wherein the plant belongs to a division Tracheophyta or any cultivar or subspecies thereof.

139. The method of claim 134, wherein the plant belongs to a subdivision Spermatophytina or any cultivar or subspecies thereof.

140. The method of claim 134, wherein the plant belongs to a class Magnoliopsida or any cultivar or subspecies thereof.

141. The method of claim 134, wherein the plant belongs to a superorder selected from Rosanae and Asteranae, or any cultivar or subspecies thereof.

142. The method of claim 134, wherein the plant belongs to an order selected from Rosales, Brassicales, Asterales, Vitales, and Solanales or any cultivar or subspecies thereof.

143. The method of claim 134, wherein the plant belongs to a family selected from Brassicaceae, Asteracae, Vitacaea, Cannabaceae, and Solanacaea or any cultivar or subspecies thereof.

144. The method of claim 134, wherein the plant belongs to a genus selected from Humulus, Brassica, Eruca, Lactuca, Cannabis, Vitis, and Solanum or any cultivar or subspecies thereof.

145. The method of claim 134, wherein the plant belongs to a species Humulus japonicus, Humulus lupulus, Cannabis sativa, Cannabis indica, Cannabis ruderalis, Brassica rapa, Eruca vesicaria, Lactuca biennis, Lactuca canadensis, Lactuca floridana, Lactuca graminifolia, Lactuca hirsute, Lactuca indica, Lactuca ludoviciana, Lactuca X morssii, Lactuca sagilina, Lactuca sativa, Lactuca serriola, Lactuca terrae-novae, Lactuca virosa, Vitis acerifolia, Vitis aestivalis, Vitis amurensis, Vitis arizonica, Vitis X bourquina, Vitis californica, Vitis X champinii, Vitis cinerea, Vitis coriacea, Vitis X doaniana, Vitis girdiana, Vitis labrusca, Vitis X labruscana, Vitis monticola, Vitis mustangensis, Vitis X novae-angliae, Vitis palmata, Vitis riparia, Vitis rotundifolia, Vitis rupestris, Vitis shuttleworthii, Vitis tillifolia, Vitis vinifera, Vitis vulpina, and Solanum lycopersicum, or any cultivar or subspecies thereof.

146. The method of claim 134, wherein the plant is a lettuce, arugula, bok choy, tomato, grape, hops, hemp, cannabis, corn, or mizuna, or any cultivar or subspecies thereof.

147. The method of claim 134, wherein the plant is spinach, sunflower, canola, flax corn, rice, wheat, oat, barley, soybean, bean, pea, legume, chickpea, sorghum, sugar cane, sugar beet, cotton, potato, turnip, carrot, onion, cantaloupe, watermelon, blueberry, cherry, apple, pear, peach, cacti, date, fig, coconut, almond, walnut, pecan, cilantro, broccoli, cauliflower, zucchini, squash, pumpkin, or any cultivar or subspecies thereof.

148. The method of claim 134, wherein the plant is a tomato plant, a lettuce plant, a strawberry plant, a saffron plant, or a grape plant.

149. The method of any one of claim 108 to 148, wherein
the system uses a voltage of 5 V to generate the electromagnetic field,
the electromagnetic field comprises a sine carrier waveform, and
the modulating wave applied to the carrier waveform comprises a waveform with a modulating frequency of 16 Hz, a modulating waveform of square, and/or a modulation depth of 30%, and
wherein the production of a compound in the plant is modified as compared to a plant not treated by the method.

150. The method of claim 149, wherein the plant is a cannabis plant.

151. The method of any one of claims 149 to 150, wherein the electromagnetic field is applied to the plant for at least 30 days.

152. The method of any one of claims 149 to 151, wherein the electromagnetic field is applied to the plant for 30 to 60 days.

153. The method of any one of claims 149 to 152, wherein the production of a cannabinoid and/or terpene in the plant is increased.

154. The method of any one of claims 149 to 153, wherein the production of total tetrahydrocannabinol (THC), total cannabichromene (CBC), and/or total terpene in the plant is increased.

155. The method of any one of claims 149 to 154, wherein the production of total cannabidiol (CBD) and/or total cannabigerol (CBG) in the plant is decreased.

156. The method of any one of claims 149 to 155, wherein the production of THCa, THC, CBDa, CBCa, CBGa, CBG, α-Pinene, β-Pinene, β-Caryophyllene, Humulene, Limonene, Linalool, Camphene, and/or Myrcene in the plant is modified.

157. The method of any one of claims 149 to 156, wherein the production of THCa, CBCa, α-Pinene, β-Pinene, β-Caryophyllene, Limonene, Linalool, Camphene, and/or Myrcene in the plant is increased.

158. The method of any one of claims 149 to 157, wherein the production of THC, CBDa, CBGa, CBG, and/or Humulene in the plant is decreased.

159. The method of any one of claim 108 to 148, wherein
the system uses a voltage of negative 10 to negative 24.5 kV to generate the electromagnetic field,
the electromagnetic field comprises a sine carrier waveform, and
the modulating wave applied to the carrier waveform comprises a waveform with a modulating frequency of 100 mHz, a modulating waveform of square, and/or a duty cycle of 10%, and
wherein the production of a compound in the plant is modified, the mass of the plant or a portion thereof is increased, and/or the ratio of dried flower mass to the mass of the above ground portion of a plant is increased as compared to a plant not treated by the method.

160. The method of claim 159, wherein the plant is a cannabis plant.

161. The method of any one of claims 159 to 160, wherein the electromagnetic field is applied to the plant for at least 40 days.

162. The method of any one of claims 159 to 161, wherein the electromagnetic field is applied to the plant for 40 to 80 days.

163. The method of any one of claims 159 to 162, wherein the production of a cannabinoid and/or terpene in the plant is increased.

164. The method of any one of claims 159 to 163, wherein the dried flower mass, the mass of the above ground portion of a plant, and/or the mass of the whole plant is increased.

165. The method of any one of claims 159 to 163, wherein the ratio of dried flower mass to the mass of the above ground portion of a plant is increased.

166. The method of any one of claim 108 to 148, wherein:
in a first treatment applied to the plant, the system uses
a voltage of 5 V to generate the electromagnetic field,
the electromagnetic field comprises a sine carrier waveform, and
the modulating wave applied to the carrier waveform comprises a waveform with a modulating frequency of 16 Hz, a modulating waveform of square, and/or a modulation depth of 30%; and
in a second treatment applied to the plant, the system uses
a voltage of negative 10 to negative 24.5 kV to generate the electromagnetic field,
the electromagnetic field comprises a sine carrier waveform, and
the modulating wave applied to the carrier waveform comprises a waveform with a modulating frequency of 100 mHz, a modulating waveform of square, and/or a duty cycle of 10%, and
wherein the mass of the plant or a portion thereof is decreased and/or the ratio of dried flower mass to the mass of the above ground portion of a plant is decreased as compared to a plant not treated by the method.

167. The method of claim 166, wherein the plant is a cannabis plant.

168. The method of any one of claims 166 to 167, wherein the first treatment is applied to the plant for at least 40 days and the second treatment is applied to the plant for at least 40 days.

169. The method of any one of claims 166 to 168, wherein the first treatment is applied to the plant for 40 to 80 days and the second treatment is applied to the plant for 40 to 80 days.

170. The method of any one of claims 166 to 169, wherein the dried flower mass and/or the mass of the above ground portion of a plant is decreased

171. The method of any one of claims 166 to 170, wherein the ratio of dried flower mass to the mass of the above ground portion of a plant is decreased.

172. The method of any one of claims 108 to 171, wherein the total consumption of energy to produce the modulated electromagnetic field is 1000 watts/100 ft² or less, preferably 100 watts/100 ft² or less, or more preferably 75 watts/100 ft² to 50 watts/100 ft², or more preferably 40 watts/100 ft² to 60 watts/100 ft².

173. The method of any one of claims 108 to 172, further comprising producing the modulated electromagnetic field by the plant treatment system of any one of claims 86 to 106.
